(19) United States
(12) Patent Application Publication
(10) Pub. No.: US 2025/0374326 A1
(43) Pub. Date: Dec. 4, 2025

(54) RADIO RESOURCE CONTROL STATE TRANSITION BASED ON SYSTEM INFORMATION ACQUISITION FROM A NETWORK ENERGY SAVINGS CELL

(71) Applicant: QUALCOMM Incorporated, San Diego, CA (US)

(72) Inventors: Changhwan PARK, San Diego, CA (US); Navid ABEDINI, Basking Ridge, NJ (US); Naeem AKL, BRIDGEWATER, NJ (US)

(21) Appl. No.: 18/731,216

(22) Filed: May 31, 2024

(51) Int. Cl. H04W 74/0833; H04W 8/22; H04W 68/02

(52) U.S. Cl. CPC H04W 74/0833; H04W 8/22; H04W 68/02

(57) ABSTRACT

Methods, systems, and devices for wireless communication are described. Various aspects generally relate to radio resource control (RRC) state transitions based on system information acquisition from a network energy savings (NES) cell. Some aspects more specifically relate to mechanisms according to which a user equipment (UE) and an NES cell may communicate system information and establish an RRC connection via a single random access procedure. In such aspects, the UE and the NES cell may use a time span for communication of a random access response that is based on the NES cell transmitting system information prior to transmitting the random access response. Some further aspects more specifically relate to mechanisms according to which the UE may provide an NES cell with information to use for determining whether to perform paging. In such aspects, the information may include one or more communication metrics.

### FIELD OF TECHNOLOGY

The following relates to wireless communication, including radio resource control (RRC) state transition based on system information acquisition from a network energy savings (NES) cell.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communication systems, a network entity may broadcast system information that indicates one or more parameters pertaining to communication with the network entity. A UE may receive the system information and communicate with the network entity in accordance with the system information. The network entity may transmit different types of system information, including minimum system information (MSI) and other system information (OSI). In some systems, the network entity may transmit MSI periodically and may transmit OSI in accordance with receiving a request from a UE.

### SUMMARY

The systems, methods, and devices of this disclosure each have several innovative aspects, no single one of which is solely responsible for the desirable attributes disclosed herein.

A method for wireless communication by a user equipment (UE) is described. The method may include transmitting, to a first network entity via a random access message, information indicative of a request by the UE to remain in an idle state or an inactive state associated with the first network entity, receiving, from the first network entity, a response message associated with the random access message that indicates a mode of operation for the UE in accordance with the request by the UE to remain in the idle state or the inactive state associated with the first network entity, and monitoring for one or more paging messages from the first network entity or a second network entity in accordance with the mode of operation indicated by the response message.

A UE for wireless communication is described. The UE may include one or more memories storing processor executable code, and one or more processors coupled with the one or more memories. The one or more processors may individually or collectively be operable to execute the code to cause the UE to transmit, to a first network entity via a random access message, information indicative of a request by the UE to remain in an idle state or an inactive state associated with the first network entity, receive, from the first network entity, a response message associated with the random access message that indicates a mode of operation for the UE in accordance with the request by the UE to remain in the idle state or the inactive state associated with the first network entity, and monitor for one or more paging messages from the first network entity or a second network entity in accordance with the mode of operation indicated by the response message.

Another UE for wireless communication is described. The UE may include means for transmitting, to a first network entity via a random access message, information indicative of a request by the UE to remain in an idle state or an inactive state associated with the first network entity, means for receiving, from the first network entity, a response message associated with the random access message that indicates a mode of operation for the UE in accordance with the request by the UE to remain in the idle state or the inactive state associated with the first network entity, and means for monitoring for one or more paging messages from the first network entity or a second network entity in accordance with the mode of operation indicated by the response message.

A non-transitory computer-readable medium storing code for wireless communication is described. The code may include instructions executable by one or more processors to transmit, to a first network entity via a random access message, information indicative of a request by the UE to remain in an idle state or an inactive state associated with the first network entity, receive, from the first network entity, a response message associated with the random access message that indicates a mode of operation for the UE in accordance with the request by the UE to remain in the idle state or the inactive state associated with the first network entity, and monitor for one or more paging messages from the first network entity or a second network entity in accordance with the mode of operation indicated by the response message.

Some examples of the method, UEs, and non-transitory computer-readable medium described herein may further include operations, features, means, or instructions for transmitting, to the first network entity, an indication of a metric associated with communication between the UE and the second network entity, where receiving the response message that indicates the mode of operation for the UE may be in association with transmitting the indication of the metric associated with the communication between the UE and the second network entity.

Some examples of the method, UEs, and non-transitory computer-readable medium described herein may further include operations, features, means, or instructions for receiving, from the first network entity in association with transmitting the random access message, a request for the metric associated with the communication between the UE and the second network entity, where transmitting the indication of the metric may be in association with receiving the request.

In some examples of the method, UEs, and non-transitory computer-readable medium described herein, the UE includes the indication of the metric associated with the communication between the UE and the second network entity in the random access message.

In some examples of the method, UEs, and non-transitory computer-readable medium described herein, receiving the response message that indicates the mode of operation for the UE may include operations, features, means, or instructions for receiving an indication to monitor a paging channel associated with the second network entity in accordance with the metric satisfying a threshold value, where the mode of operation includes monitoring the paging channel associated with the second network entity.

In some examples of the method, UEs, and non-transitory computer-readable medium described herein, receiving the response message that indicates the mode of operation for the UE may include operations, features, means, or instructions for receiving an indication to monitor a paging channel associated with the first network entity in accordance with the metric failing to satisfy a threshold value, where the mode of operation includes monitoring the paging channel associated with the first network entity.

In some examples of the method, UEs, and non-transitory computer-readable medium described herein, the random access message further includes one or more parameters associated with the UE and the mode of operation may be further in accordance with the one or more parameters associated with the UE.

A method for wireless communication by a UE is described. The method may include transmitting a random access message to a first network entity, receiving, from the first network entity, one or more system information blocks (SIBs) in association with transmitting the random access message, and monitoring for a response message associated with the random access message within a time span that is based on receiving the one or more SIBs in association with transmitting the random access message.

A UE for wireless communication is described. The UE may include one or more memories storing processor executable code, and one or more processors coupled with the one or more memories. The one or more processors may individually or collectively be operable to execute the code to cause the UE to transmit a random access message to a first network entity, receive, from the first network entity, one or more SIBs in association with transmitting the random access message, and monitor for a response message associated with the random access message within a time span that is based on receiving the one or more SIBs in association with transmitting the random access message.

Another UE for wireless communication is described. The UE may include means for transmitting a random access message to a first network entity, means for receiving, from the first network entity, one or more SIBs in association with transmitting the random access message, and means for monitoring for a response message associated with the random access message within a time span that is based on receiving the one or more SIBs in association with transmitting the random access message.

A non-transitory computer-readable medium storing code for wireless communication is described. The code may include instructions executable by one or more processors to transmit a random access message to a first network entity, receive, from the first network entity, one or more SIBs in association with transmitting the random access message, and monitor for a response message associated with the random access message within a time span that is based on receiving the one or more SIBs in association with transmitting the random access message.

Some examples of the method, UEs, and non-transitory computer-readable medium described herein may further include operations, features, means, or instructions for transmitting, via the random access message or a second random access message, first information indicative of a request by the UE to enter a connected state associated with the first network entity and second information indicative of one or more parameters associated with the UE.

Some examples of the method, UEs, and non-transitory computer-readable medium described herein may further include operations, features, means, or instructions for receiving, from the first network entity, an acceptance or a rejection of the request by the UE to enter the connected state associated with the first network entity based on the one or more parameters.

In some examples of the method, UEs, and non-transitory computer-readable medium described herein, the one or more SIBs may be based on the one or more parameters associated with the UE.

Some examples of the method, UEs, and non-transitory computer-readable medium described herein may further include operations, features, means, or instructions for obtaining an indication of an extension time associated with a time window corresponding to the response message, where the time span includes the time window and the extension time in accordance with receiving the one or more SIBs in association with transmitting the random access message.

Some examples of the method, UEs, and non-transitory computer-readable medium described herein may further include operations, features, means, or instructions for obtaining an indication of a time offset associated with a time window corresponding to the response message, where the time span includes the time window, and where the time window may be offset from a transmission time of the random access message by the time offset in accordance with receiving the one or more SIBs in association with transmitting the random access message.

A method for wireless communication by a first network entity is described. The method may include obtaining, via a random access message, information indicative of a request by a UE to remain in an idle state or an inactive state with respect to the first network entity, outputting a response message associated with the random access message that indicates a mode of operation for the UE in accordance with the request by the UE to remain in the idle state or the inactive state with respect to the first network entity, and selectively outputting one or more paging messages in accordance with the mode of operation indicated by the response message.

A first network entity for wireless communication is described. The first network entity may include one or more memories storing processor executable code, and one or more processors coupled with the one or more memories. The one or more processors may individually or collectively be operable to execute the code to cause the first network entity to obtain, via a random access message, information indicative of a request by a UE to remain in an idle state or an inactive state with respect to the first network entity, output a response message associated with the random access message that indicates a mode of operation for the UE in accordance with the request by the UE to remain in the idle state or the inactive state with respect to the first network entity, and selectively output one or more paging messages in accordance with the mode of operation indicated by the response message.

Another first network entity for wireless communication is described. The first network entity may include means for obtaining, via a random access message, information indicative of a request by a UE to remain in an idle state or an inactive state with respect to the first network entity, means for outputting a response message associated with the random access message that indicates a mode of operation for the UE in accordance with the request by the UE to remain in the idle state or the inactive state with respect to the first network entity, and means for selectively outputting one or more paging messages in accordance with the mode of operation indicated by the response message.

A non-transitory computer-readable medium storing code for wireless communication is described. The code may include instructions executable by one or more processors to obtain, via a random access message, information indicative of a request by a UE to remain in an idle state or an inactive state with respect to the first network entity, output a response message associated with the random access message that indicates a mode of operation for the UE in accordance with the request by the UE to remain in the idle state or the inactive state with respect to the first network entity, and selectively output one or more paging messages in accordance with the mode of operation indicated by the response message.

Some examples of the method, first network entities, and non-transitory computer-readable medium described herein may further include operations, features, means, or instructions for obtaining an indication of a metric associated with communication between the UE and a second network entity, where outputting the response message that indicates the mode of operation for the UE may be in association with obtaining the indication of the metric associated with the communication between the UE and the second network entity.

Some examples of the method, first network entities, and non-transitory computer-readable medium described herein may further include operations, features, means, or instructions for outputting, in association with obtaining the random access message, a request for the metric associated with the communication between the UE and the second network entity, where obtaining the indication of the metric may be in association with receiving the request.

In some examples of the method, first network entities, and non-transitory computer-readable medium described herein, the random access message includes the indication of the metric associated with the communication between the UE and the second network entity.

In some examples of the method, first network entities, and non-transitory computer-readable medium described herein, outputting the response message that indicates the mode of operation for the UE may include operations, features, means, or instructions for outputting an indication to monitor a paging channel associated with the second network entity in accordance with the metric satisfying a threshold value, where the mode of operation includes monitoring the paging channel associated with the second network entity.

In some examples of the method, first network entities, and non-transitory computer-readable medium described herein, outputting the response message that indicates the mode of operation for the UE may include operations, features, means, or instructions for outputting an indication to monitor a paging channel associated with the first network entity in accordance with the metric failing to satisfy a threshold value, where the mode of operation includes monitoring the paging channel associated with the first network entity.

In some examples of the method, first network entities, and non-transitory computer-readable medium described herein, the random access message further includes one or more parameters associated with the UE and the mode of operation may be further in accordance with the one or more parameters associated with the UE.

A method for wireless communication by a first network entity is described. The method may include obtaining a random access message, outputting one or more SIBs in association with obtaining the random access message, and outputting a response message associated with the random access message within a time span that is based on outputting the one or more SIBs in association with obtaining the random access message.

A first network entity for wireless communication is described. The first network entity may include one or more memories storing processor executable code, and one or more processors coupled with the one or more memories. The one or more processors may individually or collectively be operable to execute the code to cause the first network entity to obtain a random access message, output one or more SIBs in association with obtaining the random access message, and output a response message associated with the random access message within a time span that is based on outputting the one or more SIBs in association with obtaining the random access message.

Another first network entity for wireless communication is described. The first network entity may include means for obtaining a random access message, means for outputting one or more SIBs in association with obtaining the random access message, and means for outputting a response message associated with the random access message within a time span that is based on outputting the one or more SIBs in association with obtaining the random access message.

A non-transitory computer-readable medium storing code for wireless communication is described. The code may include instructions executable by one or more processors to obtain a random access message, output one or more SIBs in association with obtaining the random access message, and output a response message associated with the random access message within a time span that is based on outputting the one or more SIBs in association with obtaining the random access message.

Some examples of the method, first network entities, and non-transitory computer-readable medium described herein may further include operations, features, means, or instructions for obtaining, via the random access message or a second random access message, first information indicative of a request by a UE to enter a connected state associated with the first network entity and second information indicative of one or more parameters associated with the UE.

Some examples of the method, first network entities, and non-transitory computer-readable medium described herein may further include operations, features, means, or instructions for outputting an acceptance or a rejection of the request by the UE to enter the connected state associated with the first network entity based on the one or more parameters.

In some examples of the method, first network entities, and non-transitory computer-readable medium described herein, the one or more SIBs may be based on the one or more parameters associated with the UE.

Some examples of the method, first network entities, and non-transitory computer-readable medium described herein may further include operations, features, means, or instructions for obtaining an indication of an extension time associated with a time window corresponding to the response message, where the time span includes the time window and the extension time in accordance with outputting the one or more SIBs in association with obtaining the random access message.

Some examples of the method, first network entities, and non-transitory computer-readable medium described herein may further include operations, features, means, or instructions for obtaining an indication of a time offset associated with a time window corresponding to the response message, where the time span includes the time window, and where the time window may be offset from a transmission time of the random access message by the time offset in accordance with outputting the one or more SIBs in association with obtaining the random access message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports radio resource control (RRC) state transition based on system information acquisition from a network energy savings (NES) cell in accordance with one or more aspects of the present disclosure.

FIG. 2 shows examples of on-demand other system information (OSI) procedures that support RRC state transition based on system information acquisition from an NES cell in accordance with one or more aspects of the present disclosure.

FIG. 3 shows an example of a signaling diagram that supports RRC state transition based on system information acquisition from an NES cell in accordance with one or more aspects of the present disclosure.

FIG. 4 shows an example of a communication timeline that supports RRC state transition based on system information acquisition from an NES cell in accordance with one or more aspects of the present disclosure.

FIGS. 5 and 6 show examples of process flows that support RRC state transition based on system information acquisition from an NES cell in accordance with one or more aspects of the present disclosure.

FIGS. 7 and 8 show block diagrams of devices that support RRC state transition based on system information acquisition from an NES cell in accordance with one or more aspects of the present disclosure.

FIG. 9 shows a block diagram of a communications manager that supports RRC state transition based on system information acquisition from an NES cell in accordance with one or more aspects of the present disclosure.

FIG. 10 shows a diagram of a system including a device that supports RRC state transition based on system information acquisition from an NES cell in accordance with one or more aspects of the present disclosure.

FIGS. 11 and 12 show block diagrams of devices that support RRC state transition based on system information acquisition from an NES cell in accordance with one or more aspects of the present disclosure.

FIG. 13 shows a block diagram of a communications manager that supports RRC state transition based on system information acquisition from an NES cell in accordance with one or more aspects of the present disclosure.

FIG. 14 shows a diagram of a system including a device that supports RRC state transition based on system information acquisition from an NES cell in accordance with one or more aspects of the present disclosure.

FIGS. 15-20 show flowcharts illustrating methods that support RRC state transition based on system information acquisition from an NES cell in accordance with one or more aspects of the present disclosure.

### DETAILED DESCRIPTION

In some wireless communication networks, a network entity may operate in accordance with a network energy savings (NES) mode. Such a network entity operating in accordance with an NES mode may be referred to herein as an NES cell. Further, operating in accordance with an NES mode may include or be associated with one or more protocols or mechanisms according to which an NES cell may transmit relatively less signaling or spend some time durations in an inactive, sleep, low power, or off state. For example, some NES cells may refrain from periodically broadcasting some system information, such as a primary system information block (SIB) (e.g., a SIB1). Instead, such NES cells may transmit system information in accordance with receiving a request from a user equipment (UE) (e.g., in an on-demand manner). An NES cell that transmits SIB1 in an on-demand manner may be referred to herein as an on-demand (OD) SIB1 (OD-SIB1) NES cell. For further example, some NES cells may selectively transmit paging messages. In such examples, an NES cell may transmit paging messages during some time periods (e.g., when the NES cell is in an active mode) and may refrain from transmitting paging messages during some other time periods (e.g., when the NES cell is in a power save mode).

In some scenarios, a UE may attempt to establish a connection (e.g., a radio resource control (RRC) connection) with or receive paging messages from an NES cell. To wake up the NES cell for the establishment of the connection or for the transmission of the paging messages, the UE may transmit a random access preamble via a physical random access channel (PRACH) occasion associated with the NES cell. Such a random access preamble, which may be a message 1 (msg1) or a PRACH portion of a message A (msgA), may trigger or cause the NES cell to transmit at least SIB1. In some cases, a transmission of SIB1 after receiving the random access preamble may delay one or more subsequent random access messages, such as a message 2 (msg2), a message 4 (msg4), or a message B (msgB), which may risk violating one or more timers associated with the random access procedure (e.g., one or more timers defined by one or more of an ra-ResponseWindow value, an ra-ContentionResolutionTimer value, or a msgB-ResponseWindow value). If a timer associated with the random access procedure is violated, the UE may declare a connection failure and transmit another random access preamble, which may increase UE and network power consumption and result in a connection delay. Further, even if the UE transmits the random access preamble to wake up the NES cell for paging and does not intend to establish a connection with the NES cell, the NES cell may lack information to use for suitably determining whether or not to transmit paging messages for the UE. Thus, some networks may benefit from additional or alternative signaling mechanisms associated with RRC state transitions or paging after OD-SIB1 acquisition or after otherwise waking up an NES cell.

Various aspects of the present disclosure generally relate to RRC state transitions based on system information (e.g., SIB1) acquisition from an NES cell. Some aspects more specifically relate to one or more signaling- or configuration-based mechanisms according to which a UE and an NES cell may more reliably communicate system information and establish an RRC connection via a single random access procedure. In examples in which the UE intends to establish an RRC connection with the NES cell, the UE may indicate the intention of the UE via a random access message (e.g., a message 3 (msg3) or a physical uplink shared channel (PUSCH) portion of a msgA). Additionally, in such examples, the UE and the NES cell may use a time span for communication of a msg2, a msg4, or a msgB that is associated with (e.g., dedicated to or activated in) scenarios in which the NES cell transmits a SIB prior to transmitting the msg2, the msg4, or the msgB. Such a time span may be associated with a time offset or an extension time to provide sufficient time for the UE and the NES cell to communicate (e.g., transmit and receive) one or more SIBs and responsive random access signaling.

Some further aspects more specifically relate to one or more signaling- or configuration-based mechanisms according to which a UE may provide an NES cell with additional information to use for determining whether to transmit paging messages. In examples in which the UE intends to stay in an RRC idle or inactive mode and receive paging from the NES cell, the UE may indicate the intention of the UE via a random access message (e.g., a msg3 or a PUSCH portion of a msgA). Additionally, in such examples, the UE may provide information indicative of a communication metric, such as a signal strength metric or a signal quality metric, of another (e.g., alternative) network entity from which the UE may receive paging. The NES cell may indicate a mode of operation for the UE based on the communication metric. In some implementations, the mode of operation may relate to whether the UE is to monitor for paging from the NES cell or from the other network entity. Some further aspects relate to mechanisms according to which the UE may transmit, to the NES cell, additional information via a random access message and according to which the NES cell may tailor (e.g., generate or construct) one or more SIBs based on the information provided by the UE.

Particular implementations of the subject matter of the present disclosure may be implemented to realize one or more of the following advantages. In some examples, by using a time span for communication of a msg2, a msg4, or a msgB that is associated with scenarios in which the NES cell transmits one or more SIBs prior to transmitting the msg2, the msg4, or the msgB, the UE may be more likely to receive the msg2, the msg4, or the msgB within an expected time window and less likely to declare a connection failure. Accordingly, the UE may have a lower likelihood of transmitting another random access preamble and restarting a random access procedure, which may result in greater power savings at both the UE and the NES cell and lower connection times. Further, by enabling the NES cell to selectively or conditionally determine whether to support paging for the UE, the NES cell may balance power savings with network coverage. For example, in accordance with receiving an indication of a communication metric of another (e.g., alternative) network entity from which the UE may receive paging, the NES cell may determine to provide paging if a signal strength from the other network entity is relatively low and may determine to not provide paging if the signal strength from the other network entity is relatively high. Moreover, by providing information that the NES cell may use for generating or tailoring the system information requested by the UE, the NES cell may provide more relevant information to the UE, which may lower signaling overhead and simplify (e.g., reduce) processing at the UE. In accordance with such greater power savings, reduced connection times, lower signaling overhead, and simplified processing, the UE and the NES cell may further achieve or experience higher network energy efficiency, longer battery life, reduced implementation costs, greater system capacity, higher data rates, and greater spectral efficiency, among other benefits.

Aspects of the disclosure are initially described in the context of wireless communications systems. Additionally, aspects of the disclosure are illustrated by and described with reference to process flows, a signaling diagram, and a communication timeline. Aspects of the disclosure are further illustrated by and described with reference to apparatus diagrams, system diagrams, and flowcharts that relate to radio resource control state transition based on system information acquisition from a network energy savings cell.

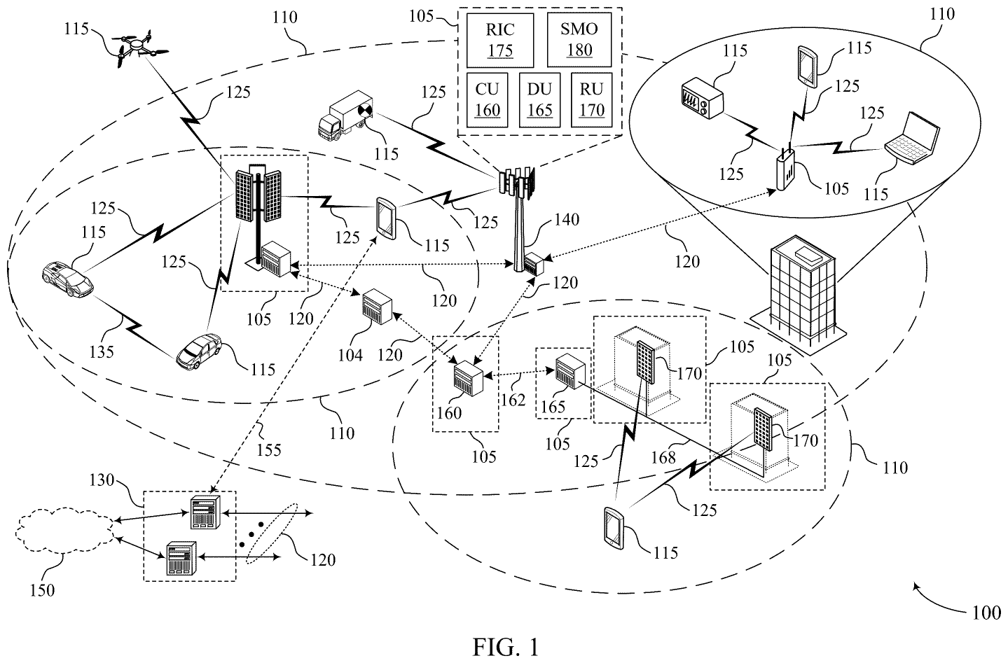

FIG. 1 shows an example of a wireless communications system 100 that supports radio resource control state transition based on system information acquisition from a network energy savings cell in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers. In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some aspects, the wireless communications system 100 may support energy saving modes, mechanisms, or operations. For example, one or more wireless communication devices of the wireless communications system 100, such as one or more network entities 105 or one or more UEs 115, may support or operate in accordance with an NES mode. In accordance with an NES mode, a wireless communication device may transmit relatively less signaling during at least some time periods as compared to a wireless communication device that does not operate in accordance with an NES mode. Wireless communication devices operating in accordance with an NES mode may, for example, implement discontinuous reception (DRX) or discontinuous transmission (DTX), or both. Additionally, or alternatively, wireless communication devices operating in accordance with an NES mode may selectively transmit one or more types of signaling. For example, a wireless communication device operating in accordance with an NES mode may transmit some types of signaling in an on-demand manner (and may refrain from transmitting such types of signaling, for example, periodically). In an example, a wireless communication device may transmit one or more SIBs (including, for example, SIB1) in accordance with receiving a request for the SIB(s). A wireless communication device, such as a network entity 105, that operates in accordance with an NES mode may be referred to herein as an NES cell.

Various wireless communication devices may support one or more procedures or signaling mechanisms or protocols associated with supporting on-demand SIB1 (e.g., OD-SIB1) for UEs 115 in idle or inactive modes (e.g., RRC idle or inactive states). In some aspects, such procedures and signaling may relate to triggering mechanisms by an uplink wake-up-signal via one or more of various channels or signals. Additionally, or alternatively, such procedures and signaling may relate to wake-up-signal configuration provisioning to a UE 115. A wake-up-signal may include, for example, a random access preamble, such as a msg1 or a PRACH portion of a msgA. Additionally, or alternatively, such procedures and signaling may relate to an information exchange between network entities 105, such as for at least the configuration of the wake-up-signal. In some aspects, network entities 105 may perform such an information exchange as suitable or relevant, such as based on a deployment scenario, operating conditions, or modes employed by one or more of the network entities 105.

In some implementations, one or more UEs 115 or one or more network entities 105, or any combination thereof, may support RRC state transitions based on system information (e.g., SIB1) acquisition from an NES cell. For example, one or more UEs 115 or one or more network entities 105, or any combination thereof, may support one or more signaling- or configuration-based mechanisms according to which a UE 115 and a network entity 105 (e.g., an NES cell) may more reliably communicate system information and establish an RRC connection via a single random access procedure or according to which a UE 115 may provide a network entity 105 (e.g., an NES cell) with additional information to use for determining whether to transmit paging messages. In examples in which the UE 115 intends to establish an RRC connection with the network entity 105 (e.g., the NES cell), the UE 115 may indicate the intention of the UE 115 via a random access message (e.g., a msg3 or a PUSCH portion of a msgA). Additionally, in such examples, the UE 115 and the network entity 105 (e.g., the NES cell) may use a time span for communication of a msg2, a msg4, or a msgB that is associated with (e.g., dedicated to or activated in) scenarios in which the network entity 105 transmits a SIB prior to transmitting the msg2, the msg4, or the msgB. Such a time span may be associated with a time offset or an extension time to provide sufficient time for the UE 115 and the network entity 105 to communicate one or more SIBs and responsive random access signaling (without violating a timer associated with the responsive random access signaling).

In examples in which the UE 115 intends to stay in an RRC idle or inactive mode and receive paging from the network entity 105 (e.g., the NES cell), the UE 115 may indicate the intention of the UE 115 via a random access message (e.g., a msg3 or a PUSCH portion of a msgA). Additionally, in such examples, the UE 115 may provide information indicative of a communication metric, such as a signal strength metric or a signal quality metric, of another (e.g., alternative or second) network entity 105 from which the UE 115 may receive paging. Such an alternative or second network entity 105 may be an anchor network entity 105 of the wireless communications system 100. The network entity 105 (e.g., the NES cell) may indicate a mode of operation for the UE 115 based on the communication metric. In some implementations, the mode of operation may relate to whether the UE 115 is to monitor for paging from the NES cell or from the other (e.g., second) network entity 105. Some further aspects relate to mechanisms according to which the UE 115 may transmit, to the network entity 105 (e.g., the NES cell), additional information via a random access message and according to which the network entity 105 may tailor (e.g., generate or construct) one or more SIBs based on the information provided by the UE 115.

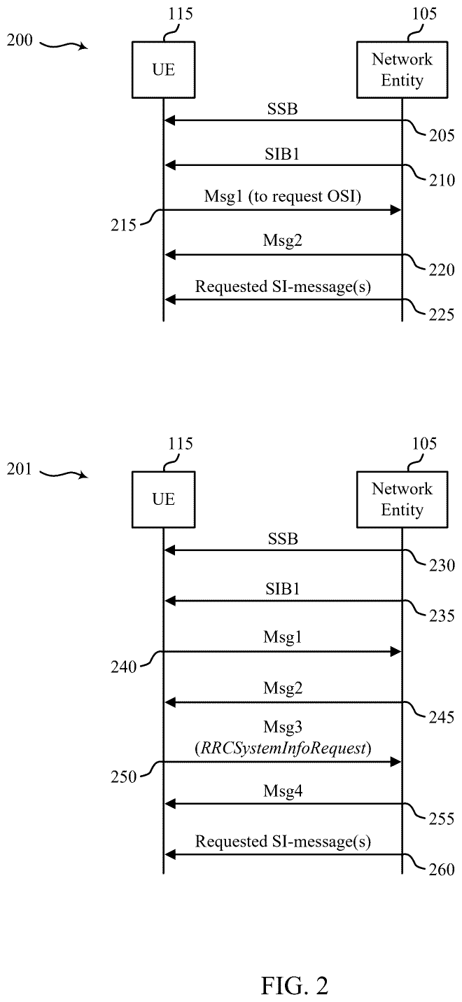

FIG. 2 shows examples of on-demand other system information (OSI) procedures 200 and 201 that support RRC state transition based on system information acquisition from an NES cell in accordance with one or more aspects of the present disclosure. Such OSI may include one or more SIBs outside of SIB1. In other words, OSI may not include SIB1. The on-demand OSI procedure 200 may illustrate an example of a contention-free random access (CFRA) procedure for acquisition of on-demand OSI and the on-demand OSI procedure 201 may illustrate an example of a contention-based random access (CBRA) procedure for acquisition of on-demand OSI.

As illustrated in the example of the on-demand OSI procedure 200, at 205, a UE 115 may receive an SSB (or, generally, one or more SSBs) from a network entity 105. At 210, the UE 115 may receive a SIB1. In some examples, the SIB1 may include or indicate random access resources within an SI-RequestConfig element, field, or parameter. In some examples, the included or indicated random access resources may be linked to one or more system information messages that the UE 115 may request from the network entity 105. For example, a first random access resource may be linked to a first set of one or more system information messages and a second random access resource may be linked to a second set of one or more system information messages. The included or indicated random access resources may include one or more PRACH occasions or one or more random access preambles, or any combination thereof. To request OSI, at 215, the UE 115 may transmit a msg1 in accordance with a random access resource of the random access resources included or indicated by the SIB1. At 220, the network entity 105 may transmit a msg2 associated with (e.g., responsive to) the msg1 and, at 225, may transmit the one or more requested system information messages (which may correspond to the random access resource that the UE 115 used for transmission of the msg1). In some examples, the UE 115 may monitor for the OSI, which the network entity 105 may transmit via a physical downlink control channel (PDCCH), after receiving the msg2.

As illustrated in the example of the on-demand OSI procedure 201, at 230, a UE 115 may receive an SSB (or, generally, one or more SSBs) from a network entity 105. At 235, the UE 115 may receive a SIB1. At 240, the UE 115 may transmit a msg1 to the network entity 105. In some examples, the UE 115 may select, such as randomly select, the random access resources used for the msg1 transmission. For example, the UE 115 may randomly select one or both of a PRACH occasion (which may be equivalently referred to as a random access channel (RACH) occasion) or a random access preamble. At 245, the network entity 105 may transmit a msg2 associated with (e.g., responsive to) the msg1. In some aspects, the msg2 may indicate an uplink grant for a msg3. At 250, the UE 115 may transmit a msg3 (e.g., via or otherwise in accordance with the uplink grant received from the network entity 105 via the msg2). In some examples, the UE 115 may include an RRCSystemInfoRequest value or parameter within the msg3. The RRCSystemInfoRequest value or parameter may indicate, to the network entity 105, that the UE 115 is requesting OSI. For example, the msg3 may include a bitmap of (e.g., a bitmap indicative of) one or more requested system information messages. At 255, the network entity 105 may transmit a msg4 associated with (e.g., responsive to) the msg3 and, at 260, the network entity 105 may transmit the one or more requested system information messages. In some examples, the UE 115 may monitor for the OSI (e.g., the requested one or more system information messages) via a PDCCH after receiving the msg4.

In accordance with the on-demand OSI procedure 200 and the on-demand OSI procedure 201, the network entity 105 may periodically broadcast SIB1 and the UE 115 may request OSI. In some deployments, however, a network entity 105 may refrain from periodically broadcasting SIB1. In such deployments, which may include deployments in which the network entity 105 operates as an NES cell or otherwise in accordance with an NES mode, a UE 115 may request the SIB1 from the network entity 105. For example, the UE 115 may transmit a random access preamble, such as via a msg1 or a PRACH portion of a msgA, to request or solicit a SIB1 from the network entity 105. Such a signaled request or solicitation may be referred to as an OD-SIB1 request signal. In some aspects, if the UE 115 sends an OD-SIB1 request signal via a msg1 or a PRACH in a msgA, the UE 115 may intend to transition an RRC state to an RRC connected state after acquiring the requested SIB information (e.g., after acquiring SIB1 information, among other system information that the UE 115 may request).

In some networks, the UE 115 may not be allowed to proceed with an RRC transition procedure before SIB (e.g., SIB1) information acquisition. Thus, to transition the RRC state of the UE 115, the UE 115 may be expected to go through a CBRA procedure from scratch again (e.g., after initiating an initial random access procedure to acquire one or more SIBs, such as SIB1). For example, the UE 115 may initiate a first random access procedure to acquire one or more SIBs and may initiate a second random access procedure to establish an RRC connection (or to otherwise transition an RRC state of the UE 115). Such a performing of multiple random access procedures may result in an increase in UE (and, in some cases, network) power consumption and a connection delay.

Further, in cases in which the UE 115 is allowed or able to include a message or indication that the UE 115 intends to transition an RRC state of the UE 115 to an RRC connected state via a msg3 or a PUSCH portion of a msgA, the UE 115 may still be unable to both acquire requested system information and establish the RRC connection within a single random access procedure. For example, even if the UE 115 is able to indicate the intention to transition to an RRC connected state via a msg3 or a PUSCH portion of a msgA, the UE 115 may still not be able to skip a transmission of msg1 or a msgA if a random access timer expires during system information (e.g., OD-SIB1) acquisition. Such a random access timer may be defined by an ra-ResponseWindow value or an ra-ContentionResolutionTimer value in examples in which the UE 115 performs a four-step random access procedure. Alternatively, such a random access timer may be defined by a msgB-ResponseWindow value in examples in which the UE 115 performs a two-step random access procedure. In accordance with such a relatively high likelihood of an expiration of a random access timer during OD-SIB1 acquisition, the UE 115 may (frequently) experience a connection failure and restart another random access procedure, which also may increase UE (and, in some cases, network) power consumption and connection delay.

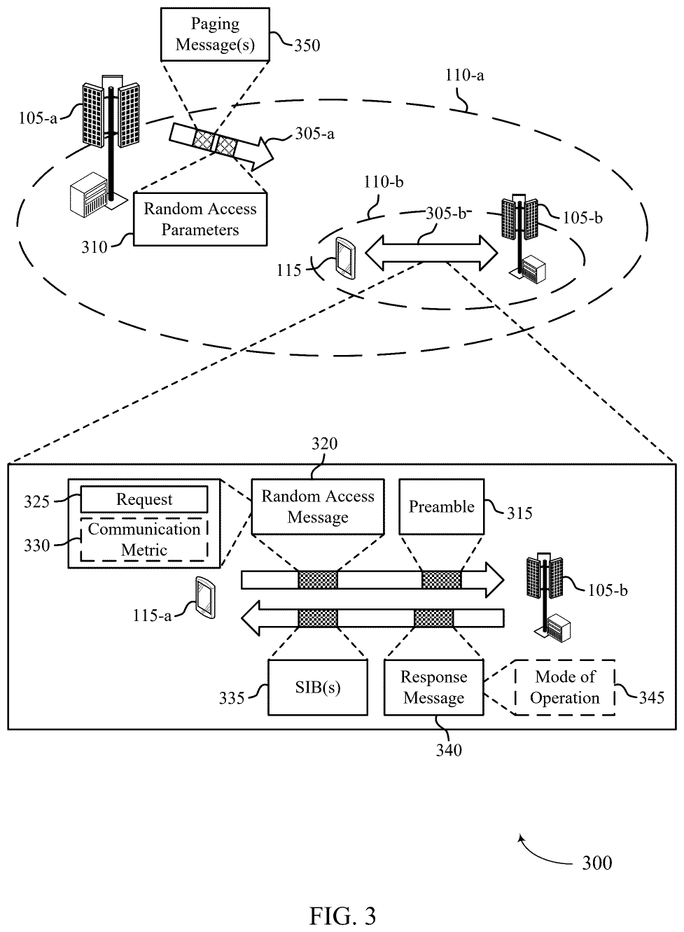

In accordance with one or more example implementations of the present disclosure, a UE 115 and a network entity 105 may more reliably communicate system information (including OD-SIB1) and establish an RRC connection via a single random access procedure, among other aspects related to efficient communication protocols between a UE 115 and a network entity 105 operating in accordance with an NES mode. Additional details relating to such aspects are illustrated and described herein, including by and with reference to FIGS. 3-6.

FIG. 3 shows an example of a signaling diagram 300 that supports RRC state transition based on system information acquisition from an NES cell in accordance with one or more aspects of the present disclosure. The signaling diagram 300 illustrates communication between or otherwise involving a network entity 105-a, a network entity 105-b, and a UE 115. The network entity 105-a and the network entity 105-b may each be an example of a network entity 105 as illustrated and described herein, including by and with reference to FIG. 1. The UE 115 may be an example of a UE 115 as illustrated and described herein, including by and with reference to FIG. 1.

The network entity 105-a, which may be an example of an anchor network entity or an anchor gNB, may support a coverage area 110-a. The network entity 105-b, which may be an example of an NES cell, may support a coverage area 110-b. The network entity 105-a may transmit, such as broadcast, via a communication link 305-a. The network entity 105-b and the UE 115 may communicate (e.g., transmit or receive, or both) via a communication link 305-b.

In implementations in which the network entity 105-b operates in accordance with an NES mode, the network entity 105-b may refrain from periodically broadcasting system information, including SIB1. In such implementations, the network entity 105-a may transmit (e.g., broadcast) information (e.g., assistance information) associated with accessing or connecting with the network entity 105-b. For example, the network entity 105-a may transmit information indicative of a set of random access parameters 310 that the UE 115 may use to solicit SIB1 from the network entity 105-b or to attempt to establish a connection with the network entity 105-b, or both. Such a set of random access parameters 310 may include one or more random access preambles, one or more PRACH occasions, one or more PUSCH occasions, or any combination thereof.

In implementations in which the UE 115 attempts to establish a connection with the network entity 105-b or attempts to otherwise have the network entity 105-b provide paging to the UE 115, the UE 115 may transmit a random access preamble 315 to the network entity 105-b in accordance with (e.g., via or using) a random access resource from the set of random access parameters 310. Such a random access preamble 315 may be an example of a msg1 or a PRACH portion of a msgA. In some implementations, the UE 115 may transmit a random access message 320 in association with transmitting the random access preamble 315. The random access message 320 may be an example of a msg3 or a PUSCH portion of a msgA.

In some examples, the random access message 320 may include a request 325. The request 325 may be a request to remain in an RRC idle or inactive state associated with (e.g., with respect to) the network entity 105-b or may be a request to enter a connected state associated with (e.g., with respect to) the network entity 105-b. For example, when waking up the network entity 105-b (e.g., the OD-SIB1 NES cell) by transmitting the random access preamble 315, the UE 115 may additionally send an indication that the UE 115 intends to transition to an RRC connected state (after OD-SIB1 acquisition) via the random access message 320. Alternatively, when waking up the network entity 105-b (e.g., the OD-SIB1 NES cell) by transmitting the random access preamble 315, the UE 115 may additionally send an indication that the UE 115 intends to stay in an RRC idle or inactive state (such that, after reselecting and camping on the network entity 105-b, the UE 115 may monitor a paging channel from the network entity 105-b). In some implementations, the random access message 320 may include an indication of a communication metric 330.

One or both of the random access preamble 315 or the random access message 320 may trigger or cause the network entity 105-b to transmit one or more SIBs 335. Such one or more SIBs 335 may be one or more on-demand SIBs. In some aspects, the one or more SIBs 335 may include a SIB1, such as an OD-SIB1. The network entity 105-b may transmit a response message 340 in association with receiving one or both of the random access preamble 315 or the random access message 320. For example, the response message 340 may be an example of a msg2, a msg4, or a msgB. In some implementations, the response message 340 may include an indication of a mode of operation 345 associated with (e.g., for) the UE 115.

In some aspects, the UE 115 and the network entity 105-b may communicate one or more of the random access preamble 315, the random access message 320, the one or more SIBs 335, or the response message 340 to more reliably communicate system information and establish an RRC connection via a single random access procedure. Additionally, or alternatively, the UE 115 and the network entity 105-b may communicate one or more of the random access preamble 315, the random access message 320, the one or more SIBs 335, or the response message 340 to provide the network entity 105-b with additional information to use for determining whether to transmit paging messages to the UE 115.

For example, to more reliably communicate system information and establish an RRC connection via a single random access procedure, the UE 115 and the network entity 105-b may support a mechanism according to which the request 325 by the UE 115 may be confirmed (or denied) by the network entity 105-b and according to which the procedure of the RRC state transition may occur after the UE 115 obtains a threshold amount of system information (e.g., at least the SIB1). In such examples, the UE 115 and the network entity 105-b may support, use, activate, or employ one or more extended or offset timers to account for the delivery of the one or more SIBs 335 during the random access procedure. In other words, the UE 115 and the network entity 105-b may use one or more windows or timers that may be extended or offset by a specific amount. An amount of extension or delay may be implicitly or explicitly configured. For example, the amount of extension or delay may be signaled by the network entity 105-a (e.g., the anchor cell), by the network entity 105-b (such as via the one or more SIBs 335), or may be stored and retrieved from one or more memories associated with (e.g., accessible by) the UE 115 (e.g., in accordance with a network specification). As described herein, one or memories of or associated with a device may refer to one or more memories located at the device or one or more memories (e.g., a cloud-based storage) located separate from the device, or any combination thereof. The windows or timers may include one or more of an ra-ResponseWindow or an ra-ContentionResolutionTimer in examples in which the UE 115 and the network entity 105-b communicate in accordance with a four-step random access procedure. The windows or timers may include a msgB-ResponseWindow in examples in which the UE 115 and the network entity 105-b communicate in accordance with a two-step random access procedure.

For further example, to provide the network entity 105-b with additional information to use for determining whether to transmit paging messages to the UE 115, the network entity 105-b may respond, via the response message 340, that the UE 115 is expected or instructed to monitor a paging channel from the currently camped-on cell (e.g., the network entity 105-a) or to query a signal strength or quality of the currently camped-on cell (e.g., the network entity 105-a). The UE 115 may transmit the communication metric 330 to indicate a signal strength metric or a signal quality metric associated with communication between the UE 115 and the network entity 105-a. In some implementations, the UE 115 may indicate the communication metric 330 as an absolute value (in, for example, dBm). Additionally, or alternatively, the UE 115 may indicate the communication metric 330 as a relative value (e.g., a differential value) with respect to a second communication metric (e.g., a second signal strength metric or a second signal quality metric) associated with communication between the UE 115 and the network entity 105-b (in, for example dB). The UE 115 may measure, determine, select, or ascertain the second communication metric associated with communication between the UE 115 and the network entity 105-b in one or more of various ways, such as by measuring one or more SSBs transmitted by the network entity 105-b.

In implementations in which the UE 115 provides the communication metric 330 indicative of the signal strength or quality associated with communication between the UE 115 and the network entity 105-a, the network entity 105-b may consider the communication metric 330 associated with communication between the UE 115 and the network entity 105-a as part of determining whether to provide paging to the UE 115. In other words, the network entity 105-b may receive and parse (e.g., evaluate) the communication metric 330 associated with communication between the UE 115 and the network entity 105-a before responding or confirming whether the UE 115 is to monitor a paging channel of the network entity 105-a or a paging channel of the network entity 105-b. The network entity 105-b may indicate whether the UE 115 is to monitor a paging channel of the network entity 105-a or a paging channel of the network entity 105-b in accordance with indicating a mode of operation 345.

The network entity 105-b may provide paging to the UE 115 in accordance with the signal strength or quality associated with communication between the UE 115 and the network entity 105-a failing to satisfy (e.g., being less than) a threshold strength or quality, or in accordance with the signal strength or quality provided by the network entity 105-b being more than a threshold amount greater than the signal strength or quality provided by the network entity 105-a. The network entity 105-b may refrain from providing paging to the UE 115 in accordance with the signal strength or quality associated with communication between the UE 115 and the network entity 105-a satisfying (e.g., being greater than or equal to) the threshold strength or quality, or in accordance with the signal strength or quality provided by the network entity 105-b being less than or equal to a threshold amount greater than the signal strength or quality provided by the network entity 105-a. In examples in which the network entity 105-b refrains from providing paging to the UE 115, the network entity 105-b may indicate, via the response message 340 (e.g., via the mode of operation 345), that the UE 115 is to monitor for one or more paging messages 350 from the network entity 105-a.

In some implementations, the UE 115 may include, within the random access message 320, information indicative of a device type, a service type, or a radio capability, among other example parameters, associated with the UE 115. In such implementations, the network entity 105-b may use the information to generate, tailor, or construct the one or more SIBs 335. For example, the network entity 105-b may use the information to provide a tailored OD-SIB content. Additionally, or alternatively, the network entity 105-b may use the information to decide whether to proceed with an RRC connection procedure or to direct the UE 115 toward a specific (different) radio frequency carrier or a different cell (e.g., such as the network entity 105-a).

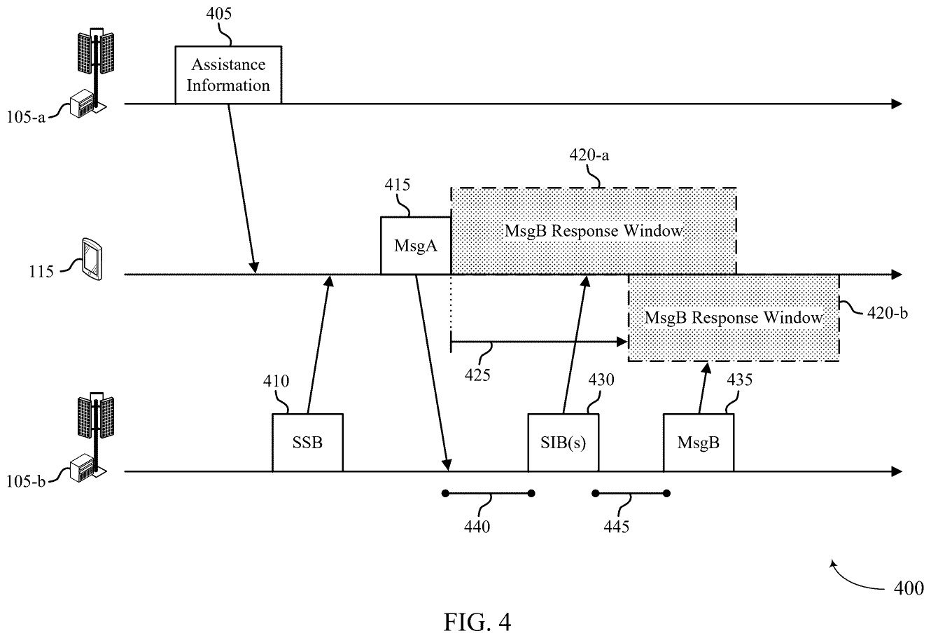

FIG. 4 shows an example of a communication timeline 400 that supports RRC state transition based on system information acquisition from an NES cell in accordance with one or more aspects of the present disclosure. The communication timeline 400 illustrates communication between a network entity 105-a, a network entity 105-b, and a UE 115. The network entity 105-a and the network entity 105-b of FIG. 4 may be examples of corresponding devices as illustrated and described herein, including the network entity 105-a and the network entity 105-b as illustrated by and described with reference to FIG. 3. The UE 115 of FIG. 4 may be an example of corresponding devices as illustrated and described herein, including the UE 115 as illustrated by and described with reference to FIG. 3.

In some implementations, the network entity 105-a may transmit assistance information 405 to the UE 115. Such assistance information 405 may include one or more parameters (e.g., one or more random access parameters) or other information that the UE 115 may use to communicate with the network entity 105-b (e.g., an NES cell). For example, the network entity 105-a may indicate, to the UE 115 via the assistance information 405, one or more parameters that the UE 115 may use to transmit an OD-SIB1 request to one or more neighbor NES cells (including, for example, the network entity 105-b). The network entity 105-a may transmit the assistance information 405 via one or more SIBs, RRC signaling (e.g., one or more RRC information elements), one or more medium access control (MAC) control elements (MAC-CEs), downlink control information (DCI), or any combination thereof.

In some examples, the network entity 105-b may transmit one or more SSBs 410. The UE 115 may receive the one or more SSBs 410 and may measure the one or more SSBs 410. In some implementations, the UE 115 may request SIB1 from the network entity 105-b or request the network entity 105-b to provide paging to the UE 115 in association with measuring the one or more SSBs 410.

In some examples, the UE 115 may transmit a msgA 415. The msgA 415 may include a PRACH portion and a PUSCH portion and, in some implementations, may convey one or more of an OD-SIB1 request, additional information associated with the UE 115 (e.g., one or more communication metrics, a device type, a service type, or a radio capability), and additional information associated with whether the UE 115 intends or requests to transition an RRC state of the UE 115. In association with transmitting the msgA 415, the UE 115 may start a msgB response window and monitor for a msgB 435 within the msgB response window. In some aspects, the msgB response window may be configured as 1, 2, 4, 8, 10, 20, 40, 80, 160, or 320 slots. In some other aspects, the msgB response window may be configured as 240, 640, 960, 1280, 1920, or 2560 slots. In some aspects, the network entity 105-a or the network entity 105-b may configure the msgB response window to a value lower than or equal to 40 milliseconds.

In some implementations, the UE 115 and the network entity 105-b may use a msgB response window 420-a to monitor for the msgB 435, which may be an example of an extended msgB response window. In such implementations, the UE 115 and the network entity 105-b may use the (extended) msgB response window 420-a if a request for an RRC state transition was made by the UE 115 (e.g., via the msgA 415) or in accordance with the msgA 415 soliciting an OD-SIB1. The msgB response window 420-a may be greater than 40 milliseconds or otherwise longer than the UE 115 and the network entity 105-b may otherwise use (e.g., if a request for an RRC state transition was not made by the UE 115, or if the network entity 105-b was not operating in accordance with an NES mode). The UE 115 may start the msgB response window 420-a from at least one symbol after a last symbol of a PUSCH portion of the msgA 415. The UE 115 may receive an indication of a duration of the msgB response window 420-a from the network entity 105-a or the network entity 105-b or may retrieve an indication of the duration of the msgB response window 420-a from one or more memories associated with the UE 115 (e.g., in accordance with a network specification).

Additionally, or alternatively, the UE 115 and the network entity 105-b may use a msgB response window 420-b to monitor for the msgB 435, which may be an example of a delayed or offset msgB response window. For example, the UE 115 and the network entity 105-b may delay or offset the start of the msgB response window 420-b by a time offset 425. In some aspects, the UE 115 and the network entity 105-b may delay the start of the msgB response window 420-b by the time offset 425 if a request for an RRC state transition was made by the UE 115 (e.g., via the msgA 415) or in accordance with the msgA 415 soliciting an OD-SIB1. In other words, the UE 115 may begin or start monitoring for the msgB 435 (or msg2 or msg4, in examples of a four-step random access procedure) and thus run a random access response window or timer following the time offset 425.

In some implementations, the UE 115 may (e.g., may be expected to) acquire and process one or more SIBs 430 (e.g., including at least SIB1) within the time offset 425. In some other implementations, the UE 115 may receive or process, or both, one or more SIBs 430 (e.g., including at least the SIB1) at least partially within the msgB response window 420-b. The UE 115 may apply the time offset 425 from at least one symbol after a last symbol of a PUSCH portion of the msgA 415. The UE 115 may receive an indication of a duration of the time offset 425 from the network entity 105-a or the network entity 105-b or may retrieve an indication of the duration of the time offset 425 from one or more memories associated with the UE 115 (e.g., in accordance with a network specification).

In association with receiving the msgA 415, the network entity 105-b may transmit one or more SIBs 430. The one or more SIBs 430 may include an OD-SIB1. In some implementations, the network entity 105-b may tailor the one or more SIBs 430 and may use a duration 440 to generate the tailored SIB information. In some implementations, the network entity 105-b may indicate a value of the duration 440 to the UE 115. Additionally, or alternatively, the UE 115 may obtain information indicative of the duration 440 via one or more memories associated with the UE 115 (e.g., in accordance with a network specification).

In association with receiving the msgA 415, the network entity 105-b may transmit a msgB 435. The msgB 435, for example, may be a response message associated with the msgA 415. The UE 115 may receive the msgB 435 via a physical downlink shared channel (PDSCH). In some examples, the UE 115 may use a duration 445 to process the one or more SIBs 430 and prepare for the msgB 435. In some implementations, the UE 115 may indicate a value of the duration 445 to the network entity 105-b. Additionally, or alternatively, the network entity 105-b may obtain information indicative of the duration 445 via one or more memories associated with the network entity 105-b (e.g., in accordance with a network specification). In some examples, the UE 115 may use a duration to decide whether to accept the RRC state transition request made by the UE 115. Such a duration may be, for example, a time between reception of the msgA 415 and transmission of the msgB 435. In some implementations, the network entity 105-b may indicate a value of such a duration to the UE 115. Additionally, or alternatively, the UE 115 may obtain information indicative of such a duration via one or more memories associated with the UE 115 (e.g., in accordance with a network specification).

Further, although the communication timeline 400 illustrates an example of an extended, offset, or delayed time span in the example of a two-step random access procedure, the UE 115, the network entity 105-a, or the network entity 105-b may employ one or more extended, offset, or delayed time spans in other random access procedures, including four-step random access procedures. For example, the UE 115, the network entity 105-a, or the network entity 105-b may support an extended, offset, or delayed random access response window or an extended, offset, or delayed random access contention resolution timer (in addition to, as an alternative from, an extended, offset, or delayed msgB response window).

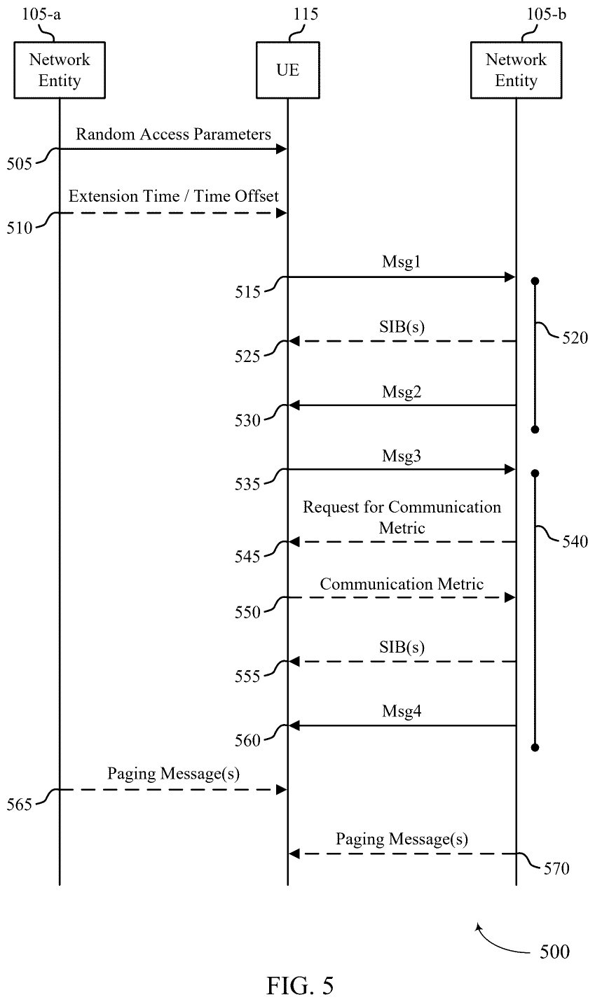

FIG. 5 shows an example of a process flow 500 that supports RRC state transition based on system information acquisition from an NES cell in accordance with one or more aspects of the present disclosure. The process flow 500 illustrates communication between a network entity 105-a, a network entity 105-b, and a UE 115. The network entity 105-a and the network entity 105-b of FIG. 5 may be examples of corresponding devices as illustrated and described herein, including the network entity 105-a and the network entity 105-b as illustrated by and described with reference to FIGS. 3 and 4. The UE 115 of FIG. 5 may be an example of corresponding devices as illustrated and described herein, including the UE 115 as illustrated by and described with reference to FIGS. 3 and 4. The process flow 500 illustrates an example in which the UE 115 and the network entity 105-b perform a four-step random access procedure.

Alternative examples of the following may be implemented. Some steps may be performed in a different order than described or may not be performed at all. In some implementations, steps may include additional features not mentioned below, or further steps may be added. Further, although example devices are shown performing the operations of the process flow 500, some aspects of some operations also may be performed by one or more other wireless communication devices without exceeding the scope of the present disclosure. For example, the network entity 105-a or the network entity 105-b may perform some aspects of some operations across multiple components, which may be disaggregated or collocated.

At 505, the UE 115 may receive one or more random access parameters from the network entity 105-a. The one or more random access parameters may be associated with an OD-SIB1 request from the network entity 105-b. The UE 115 may use the one or more random access parameters to communicate (e.g., transmit or receive, or both) random access signaling with the network entity 105-b.

At 510, the UE 115 may receive an indication of an extension time or a time offset associated with one or more time spans within which the UE 115 may expect to receive a responsive random access message (e.g., a msg2 or a msg4). The UE 115 may receive an indication of the one or more time spans from the network entity 105-a or the network entity 105-b or may retrieve an indication of the one or more time spans from one or more memories associated with the UE 115. The one or more time spans may include one or both of an ra-ResponseWindow or an ra-ContentionResolutionTimer.

At 515, the UE 115 may transmit a msg1 (e.g., a random access preamble) to the network entity 105-b. The UE 115 may transmit the msg1 in accordance with the one or more random access parameters received from the network entity 105-a. In some implementations, the UE 115 may monitor for a response message, such as a msg2, within a time span 520. The time span 520 may be an example of an ra-ResponseWindow and may be extended or offset in time in accordance with a transmission of one or more SIBs by the network entity 105-b.

At 525, the UE 115 may, in some implementations, receive one or more SIBs from the network entity 105-b. For example, in some implementations, the msg1 may trigger transmission of the one or more SIBs from the network entity 105-b. The one or more SIBs may include a SIB1, such as an OD-SIB1.

At 530, the UE 115 may receive a msg2. The msg2 may be a response message associated with the msg1. In some implementations, the UE 115 may receive the msg2 within the time span 520. The msg2 may be an example of the response message 340 as illustrated by and described with reference to FIG. 3.

At 535, the UE 115 may transmit a msg3. The msg3 may be an example of a random access message 320 as illustrated by and described with reference to FIG. 3. In some implementations, the UE 115 may monitor for a response message, such as a msg4, within a time span 540. The time span 540 may be an example of an ra-ContentionResolutionTimer and may be extended or offset in time in accordance with a transmission of one or more SIBs by the network entity 105-b.

At 545, the UE 115 may, in some implementations, receive a request for a communication metric from the network entity 105-b. In some implementations, the network entity 105-b may transmit the request for the communication metric via the msg2 or via other signaling.

At 550, the UE 115 may transmit an indication of the communication metric to the network entity 105-b. The UE 115 may transmit the indication of the communication metric via the msg3 or via other signaling. The communication metric may be indicative of or otherwise associated with a signal strength or quality of communication between the UE 115 and the network entity 105-a. For example, the communication metric may be a receive signal strength indicator (RSSI). The communication metric may be an absolute value or a relative value. In examples in which the communication metric is a relative value, the UE 115 may calculate the communication metric by determining a difference between a first signal strength or quality of communication between the UE 115 and the network entity 105-a and a second signal strength or quality of communication between the UE 115 and the network entity 105-b.

At 555, the UE 115 may, in some implementations, receive one or more SIBs from the network entity 105-b. For example, in some implementations, the msg1 or the msg3, or both collectively, may trigger transmission of the one or more SIBs from the network entity 105-b. The one or more SIBs may include a SIB1, such as an OD-SIB1. The network entity 105-b may tailor the content of the one or more SIBs based on information received from the UE 115 via the msg3.

At 560, the UE 115 may receive a msg4. The msg4 may be a response message associated with the msg3. In some implementations, the UE 115 may receive the msg4 within the time span 540. The msg4 may be an example of the response message 340 as illustrated by and described with reference to FIG. 3. The msg4 may indicate various information to the UE 115, such as an indication of a mode of operation for the UE 115 or whether the UE 115 is able to establish an RRC connection with the network entity 105-b, among other examples.

At 565, the UE 115 may monitor a paging channel associated with the network entity 105-a. The UE 115 may monitor the paging channel associated with the network entity 105-a in association with the network entity 105-b indicating the UE 115 to monitor the paging channel associated with the network entity 105-a, which may be based on the communication metric indicated by the UE 115.

At 570, the UE 115 may monitor a paging channel associated with the network entity 105-b. The UE 115 may monitor the paging channel associated with the network entity 105-b in association with the network entity 105-b indicating the UE 115 to monitor the paging channel associated with the network entity 105-b, which may be based on the communication metric indicated by the UE 115.

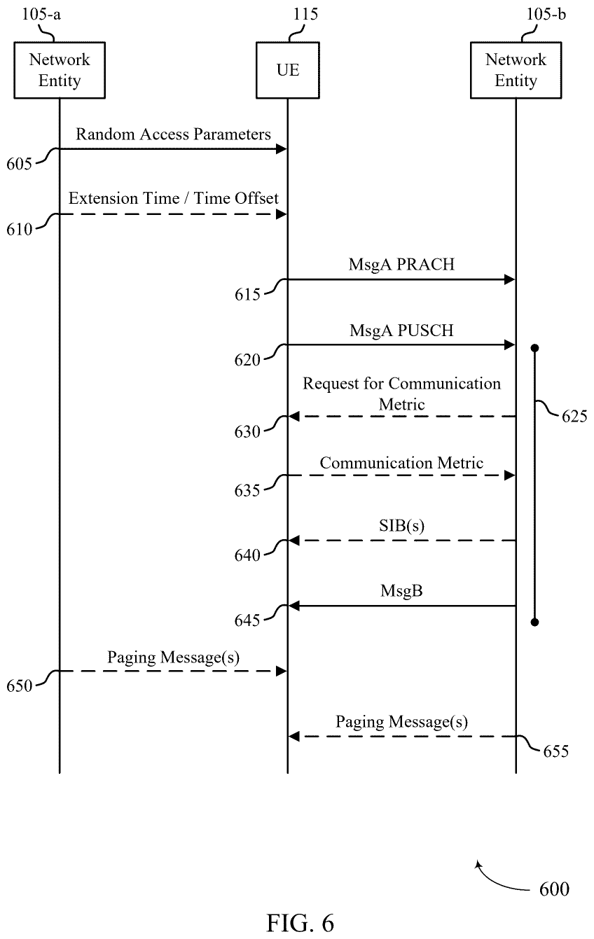

FIG. 6 shows an example of a process flow 600 that supports RRC state transition based on system information acquisition from an NES cell in accordance with one or more aspects of the present disclosure. The process flow 600 illustrates communication between a network entity 105-a, a network entity 105-b, and a UE 115. The network entity 105-a and the network entity 105-b of FIG. 6 may be examples of corresponding devices as illustrated and described herein, including the network entity 105-a and the network entity 105-b as illustrated by and described with reference to FIGS. 3 and 4. The UE 115 of FIG. 6 may be an example of corresponding devices as illustrated and described herein, including the UE 115 as illustrated by and described with reference to FIGS. 3 and 4. The process flow 600 illustrates an example in which the UE 115 and the network entity 105-b perform a two-step random access procedure.

Alternative examples of the following may be implemented. Some steps may be performed in a different order than described or may not be performed at all. In some implementations, steps may include additional features not mentioned below, or further steps may be added. Further, although example devices are shown performing the operations of the process flow 600, some aspects of some operations also may be performed by one or more other wireless communication devices without exceeding the scope of the present disclosure. For example, the network entity 105-a or the network entity 105-b may perform some aspects of some operations across multiple components, which may be disaggregated or collocated.

At 605, the UE 115 may receive one or more random access parameters from the network entity 105-a. The one or more random access parameters may be associated with an OD-SIB1 request from the network entity 105-b. The UE 115 may use the one or more random access parameters to communicate (e.g., transmit or receive, or both) random access signaling with the network entity 105-b.

At 610, the UE 115 may receive an indication of an extension time or a time offset associated with a time span within which the UE 115 may expect to receive a responsive random access message (e.g., a msgB). The UE 115 may receive an indication of the time span from the network entity 105-a or the network entity 105-b or may retrieve an indication of the time span from one or more memories associated with the UE 115. The time span be a msgB-ResponseWindow.

At 615, the UE 115 may transit a msgA PRACH (e.g., a random access preamble). The UE 115 may transmit the msgA PRACH in accordance with the one or more random access parameters received from the network entity 105-a.

At 620, the UE 115 may transmit a msgA PUSCH. The msgA PUSCH may be an example of the random access message 320 as illustrated by and described with reference to FIG. 3. In some implementations, the UE 115 may monitor for a response message, such as a msgB, within a time span 625. The time span 625 may be an example of a msgB-Response Window and may be extended or offset in time in accordance with a transmission of one or more SIBs by the network entity 105-b. The time span 625 may be the msgB response window 420-a or the msgB response window 420-b as illustrated by and described with reference to FIG. 4.

At 630, the UE 115 may, in some implementations, receive a request for a communication metric from the network entity 105-b.

At 635, the UE 115 may transmit an indication of the communication metric to the network entity 105-b. The UE 115 may transmit the indication of the communication metric via the msgA PUSCH or via other signaling. The communication metric may be indicative of or otherwise associated with a signal strength or quality of communication between the UE 115 and the network entity 105-a. For example, the communication metric may be an RSSI. The communication metric may be an absolute value or a relative value. In examples in which the communication metric is a relative value, the UE 115 may calculate the communication metric by determining a difference between a first signal strength or quality of communication between the UE 115 and the network entity 105-a and a second signal strength or quality of communication between the UE 115 and the network entity 105-b.

At 640, the UE 115 may, in some implementations, receive one or more SIBs from the network entity 105-b. For example, in some implementations, the msgA PRACH or the msgA PUSCH, or both collectively, may trigger transmission of the one or more SIBs from the network entity 105-b. The one or more SIBs may include a SIB1, such as an OD-SIB1. The network entity 105-b may tailor the content of the one or more SIBs based on information received from the UE 115 via the msgA PUSCH.

At 645, the UE 115 may receive a msgB. The msgB may be a response message associated with the msgA PRACH or PUSCH. In some implementations, the UE 115 may receive the msgB within the time span 625. The msgB may be an example of the response message 340 as illustrated by and described with reference to FIG. 3. The msgB may indicate various information to the UE 115, such as an indication of a mode of operation for the UE 115 or whether the UE 115 is able to establish an RRC connection with the network entity 105-b, among other examples.

At 650, the UE 115 may monitor a paging channel associated with the network entity 105-a. The UE 115 may monitor the paging channel associated with the network entity 105-a in association with the network entity 105-b indicating the UE 115 to monitor the paging channel associated with the network entity 105-a, which may be based on the communication metric indicated by the UE 115.

At 655, the UE 115 may monitor a paging channel associated with the network entity 105-b. The UE 115 may monitor the paging channel associated with the network entity 105-b in association with the network entity 105-b indicating the UE 115 to monitor the paging channel associated with the network entity 105-b, which may be based on the communication metric indicated by the UE 115.

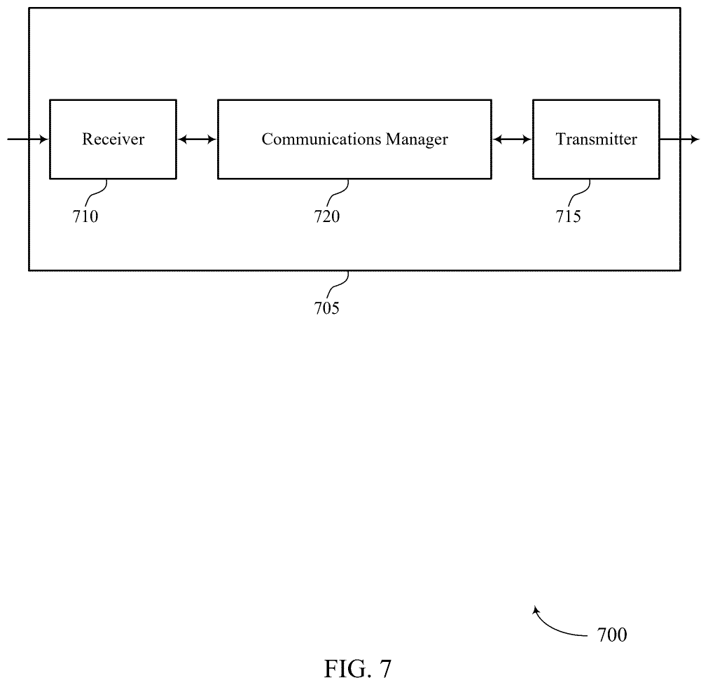

FIG. 7 shows a block diagram 700 of a device 705 that supports RRC state transition based on system information acquisition from an NES cell in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to RRC state transition based on system information acquisition from an NES cell). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to RRC state transition based on system information acquisition from an NES cell). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of RRC state transition based on system information acquisition from an NES cell as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. For example, the communications manager 720 is capable of, configured to, or operable to support a means for transmitting, to a first network entity via a random access message, information indicative of a request by the UE to remain in an idle state or an inactive state associated with the first network entity. The communications manager 720 is capable of, configured to, or operable to support a means for receiving, from the first network entity, a response message associated with the random access message that indicates a mode of operation for the UE in accordance with the request by the UE to remain in the idle state or the inactive state associated with the first network entity. The communications manager 720 is capable of, configured to, or operable to support a means for monitoring for one or more paging messages from the first network entity or a second network entity in accordance with the mode of operation indicated by the response message.

Additionally, or alternatively, the communications manager 720 may support wireless communication in accordance with examples as disclosed herein. For example, the communications manager 720 is capable of, configured to, or operable to support a means for transmitting a random access message to a first network entity. The communications manager 720 is capable of, configured to, or operable to support a means for receiving, from the first network entity, one or more SIBs in association with transmitting the random access message. The communications manager 720 is capable of, configured to, or operable to support a means for monitoring for a response message associated with the random access message within a time span that is based on receiving the one or more SIBs in association with transmitting the random access message.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, and more efficient utilization of communication resources.

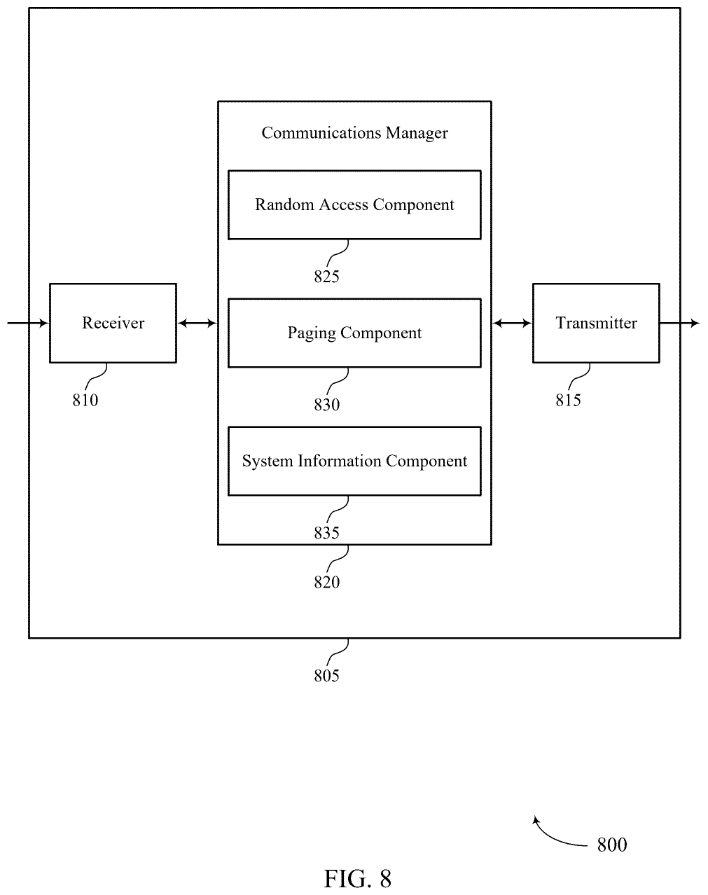

FIG. 8 shows a block diagram 800 of a device 805 that supports RRC state transition based on system information acquisition from an NES cell in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to RRC state transition based on system information acquisition from an NES cell). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to RRC state transition based on system information acquisition from an NES cell). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of RRC state transition based on system information acquisition from an NES cell as described herein. For example, the communications manager 820 may include a random access component 825, a paging component 830, a system information component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. The random access component 825 is capable of, configured to, or operable to support a means for transmitting, to a first network entity via a random access message, information indicative of a request by the UE to remain in an idle state or an inactive state associated with the first network entity. The random access component 825 is capable of, configured to, or operable to support a means for receiving, from the first network entity, a response message associated with the random access message that indicates a mode of operation for the UE in accordance with the request by the UE to remain in the idle state or the inactive state associated with the first network entity. The paging component 830 is capable of, configured to, or operable to support a means for monitoring for one or more paging messages from the first network entity or a second network entity in accordance with the mode of operation indicated by the response message.

Additionally, or alternatively, the communications manager 820 may support wireless communication in accordance with examples as disclosed herein. The random access component 825 is capable of, configured to, or operable to support a means for transmitting a random access message to a first network entity. The system information component 835 is capable of, configured to, or operable to support a means for receiving, from the first network entity, one or more SIBs in association with transmitting the random access message. The random access component 825 is capable of, configured to, or operable to support a means for monitoring for a response message associated with the random access message within a time span that is based on receiving the one or more SIBs in association with transmitting the random access message.

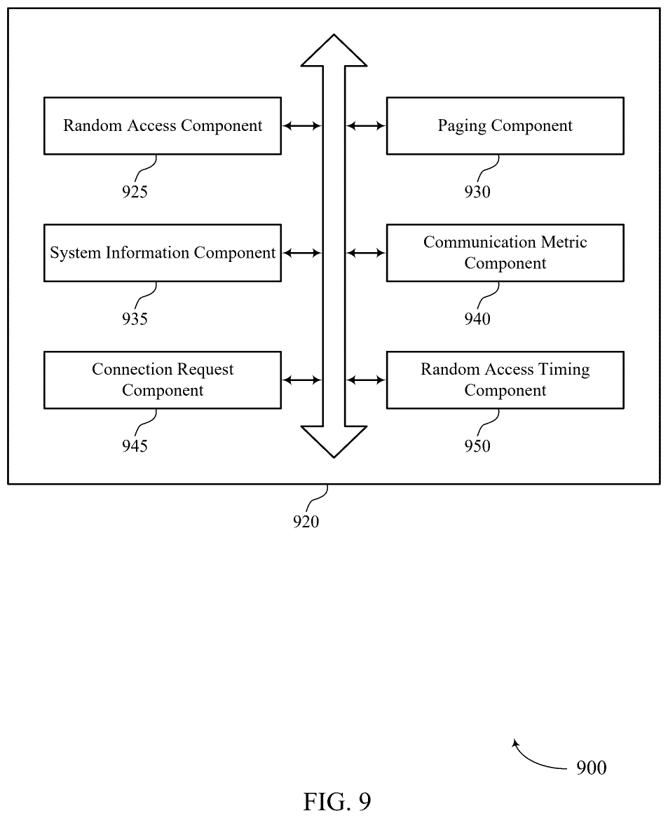

FIG. 9 shows a block diagram 900 of a communications manager 920 that supports RRC state transition based on system information acquisition from an NES cell in accordance with one or more aspects of the present disclosure. The communications manager 920 may be an example of aspects of a communications manager 720, a communications manager 820, or both, as described herein. The communications manager 920, or various components thereof, may be an example of means for performing various aspects of RRC state transition based on system information acquisition from an NES cell as described herein. For example, the communications manager 920 may include a random access component 925, a paging component 930, a system information component 935, a communication metric component 940, a connection request component 945, a random access timing component 950, or any combination thereof. Each of these components, or components or subcomponents thereof (e.g., one or more processors, one or more memories), may communicate, directly or indirectly, with one another (e.g., via one or more buses).

The communications manager 920 may support wireless communication in accordance with examples as disclosed herein. The random access component 925 is capable of, configured to, or operable to support a means for transmitting, to a first network entity via a random access message, information indicative of a request by the UE to remain in an idle state or an inactive state associated with the first network entity. In some examples, the random access component 925 is capable of, configured to, or operable to support a means for receiving, from the first network entity, a response message associated with the random access message that indicates a mode of operation for the UE in accordance with the request by the UE to remain in the idle state or the inactive state associated with the first network entity. The paging component 930 is capable of, configured to, or operable to support a means for monitoring for one or more paging messages from the first network entity or a second network entity in accordance with the mode of operation indicated by the response message.

In some examples, the communication metric component 940 is capable of, configured to, or operable to support a means for transmitting, to the first network entity, an indication of a metric associated with communication between the UE and the second network entity, where receiving the response message that indicates the mode of operation for the UE is in association with transmitting the indication of the metric associated with the communication between the UE and the second network entity.

In some examples, the communication metric component 940 is capable of, configured to, or operable to support a means for receiving, from the first network entity in association with transmitting the random access message, a request for the metric associated with the communication between the UE and the second network entity, where transmitting the indication of the metric is in association with receiving the request.

In some examples, the UE includes the indication of the metric associated with the communication between the UE and the second network entity in the random access message.

In some examples, to support receiving the response message that indicates the mode of operation for the UE, the paging component 930 is capable of, configured to, or operable to support a means for receiving an indication to monitor a paging channel associated with the second network entity in accordance with the metric satisfying a threshold value, where the mode of operation includes monitoring the paging channel associated with the second network entity.

In some examples, to support receiving the response message that indicates the mode of operation for the UE, the paging component 930 is capable of, configured to, or operable to support a means for receiving an indication to monitor a paging channel associated with the first network entity in accordance with the metric failing to satisfy a threshold value, where the mode of operation includes monitoring the paging channel associated with the first network entity.

In some examples, the metric associated with the communication between the UE and the second network entity includes an absolute value associated with the communication between the UE and the second network entity.

In some examples, the metric associated with the communication between the UE and the second network entity includes a relative value associated with a difference between a first metric associated with the communication between the UE and the second network entity and a second metric associated with second communication between the UE and the first network entity.

In some examples, the metric associated with the communication between the UE and the second network entity includes a signal strength metric or a signal quality metric.

In some examples, to support receiving the response message that indicates the mode of operation for the UE, the paging component 930 is capable of, configured to, or operable to support a means for receiving an indication to monitor a paging channel associated with the second network entity in accordance with the first network entity operating in accordance with an NES mode, where the mode of operation includes monitoring the paging channel associated with the second network entity.

In some examples, the random access message further includes one or more parameters associated with the UE. In some examples, the mode of operation is further in accordance with the one or more parameters associated with the UE.

In some examples, the one or more parameters associated with the UE include a device type associated with the UE, a service type associated with the UE, a radio capability associated with the UE, or any combination thereof.

In some examples, the random access component 925 is capable of, configured to, or operable to support a means for receiving, from the second network entity, an indication of one or more random access parameters associated with the first network entity, where the one or more random access parameters indicate at least a random access channel occasion associated with the first network entity. In some examples, the random access component 925 is capable of, configured to, or operable to support a means for transmitting a random access preamble via the random access channel occasion associated with the first network entity, where transmitting the random access message is in association with transmitting the random access preamble.

In some examples, the one or more random access parameters further indicate an uplink shared channel occasion associated with the random access channel occasion. In some examples, the UE transmits the random access message via the uplink shared channel occasion.

In some examples, the random access component 925 is capable of, configured to, or operable to support a means for receiving, from the first network entity, a random access response associated with the random access preamble, where the random access response indicates an uplink shared channel occasion, and where the UE transmits the random access message via the uplink shared channel occasion.

In some examples, the system information component 935 is capable of, configured to, or operable to support a means for receiving, from the first network entity, one or more SIBs in association with transmitting the random access preamble or the random access message.

In some examples, the random access message is a message 3 (msg3) of a four-step random access procedure or a data portion of a message A (msgA) of a two-step random access procedure.

In some examples, the first network entity is a cell operating in accordance with an NES mode.

In some examples, the request by the UE to remain in the idle state or the inactive state associated with the first network entity is associated with a request to monitor a paging channel associated with the first network entity.

Additionally, or alternatively, the communications manager 920 may support wireless communication in accordance with examples as disclosed herein. In some examples, the random access component 925 is capable of, configured to, or operable to support a means for transmitting a random access message to a first network entity. The system information component 935 is capable of, configured to, or operable to support a means for receiving, from the first network entity, one or more SIBs in association with transmitting the random access message. In some examples, the random access component 925 is capable of, configured to, or operable to support a means for monitoring for a response message associated with the random access message within a time span that is based on receiving the one or more SIBs in association with transmitting the random access message.

In some examples, the connection request component 945 is capable of, configured to, or operable to support a means for transmitting, via the random access message or a second random access message, first information indicative of a request by the UE to enter a connected state associated with the first network entity and second information indicative of one or more parameters associated with the UE.

In some examples, the connection request component 945 is capable of, configured to, or operable to support a means for receiving, from the first network entity, an acceptance or a rejection of the request by the UE to enter the connected state associated with the first network entity based on the one or more parameters.

In some examples, the one or more SIBs are based on the one or more parameters associated with the UE.

In some examples, the one or more parameters include a device type associated with the UE, a service type associated with the UE, a radio capability associated with the UE, or any combination thereof.

In some examples, the random access timing component 950 is capable of, configured to, or operable to support a means for obtaining an indication of an extension time associated with a time window corresponding to the response message, where the time span includes the time window and the extension time in accordance with receiving the one or more SIBs in association with transmitting the random access message.

In some examples, to support obtaining the indication of the extension time, the random access timing component 950 is capable of, configured to, or operable to support a means for receiving the indication of the extension time from a second network entity via RRC signaling, one or more MAC-CEs, or DCI.

In some examples, to support obtaining the indication of the extension time, the random access timing component 950 is capable of, configured to, or operable to support a means for receiving the indication of the extension time from the first network entity via the one or more SIBs.

In some examples, to support obtaining the indication of the extension time, the random access timing component 950 is capable of, configured to, or operable to support a means for retrieving the indication of the extension time from one or more memories of the UE in accordance with a rule triggered by receiving the one or more SIBs in association with transmitting the random access message.

In some examples, the random access timing component 950 is capable of, configured to, or operable to support a means for obtaining an indication of a time offset associated with a time window corresponding to the response message, where the time span includes the time window, and where the time window is offset from a transmission time of the random access message by the time offset in accordance with receiving the one or more SIBs in association with transmitting the random access message.

In some examples, the UE receives the one or more SIBs within a duration of the time offset. In some examples, the UE receives the response message within the time window.

In some examples, to support obtaining the indication of the time offset, the random access timing component 950 is capable of, configured to, or operable to support a means for receiving the indication of the time offset from a second network entity via RRC signaling, one or more MAC-CEs, or DCI.

In some examples, to support obtaining the indication of the time offset, the random access timing component 950 is capable of, configured to, or operable to support a means for receiving the indication of the time offset from the first network entity via the one or more SIBs.

In some examples, to support obtaining the indication of the time offset, the random access timing component 950 is capable of, configured to, or operable to support a means for retrieving the indication of the time offset from one or more memories of the UE in accordance with a rule triggered by receiving the one or more SIBs in association with transmitting the random access message.

In some examples, the random access component 925 is capable of, configured to, or operable to support a means for receiving, from a second network entity, an indication of one or more random access parameters associated with the first network entity, where the one or more random access parameters indicate at least a random access channel occasion associated with the first network entity. In some examples, the random access component 925 is capable of, configured to, or operable to support a means for transmitting a random access preamble via the random access channel occasion associated with the first network entity, where the random access message includes the random access preamble or is subsequent to the random access preamble.

In some examples, the one or more random access parameters further indicate an uplink shared channel occasion associated with the random access channel occasion. In some examples, in accordance with the random access message being subsequent to the random access preamble, the UE transmits the random access message via the uplink shared channel occasion.

In some examples, the random access component 925 is capable of, configured to, or operable to support a means for receiving, from the first network entity, a random access response associated with the random access preamble, where the random access response indicates an uplink shared channel occasion, and where, in accordance with the random access message being subsequent to the random access preamble, the UE transmits the random access message via the uplink shared channel occasion.

In some examples, the random access message is a msg1 or a msg3 of a four-step random access procedure or a data portion of a msgA of a two-step random access procedure. In some examples, the response message is a msg2 or a msg4 of the four-step random access procedure or a msgB of the two-step random access procedure. In some examples, the time span is associated with a random access response window, a random access contention resolution timer, or a msgB response window. In some examples, the first network entity is a cell operating in accordance with an NES mode.

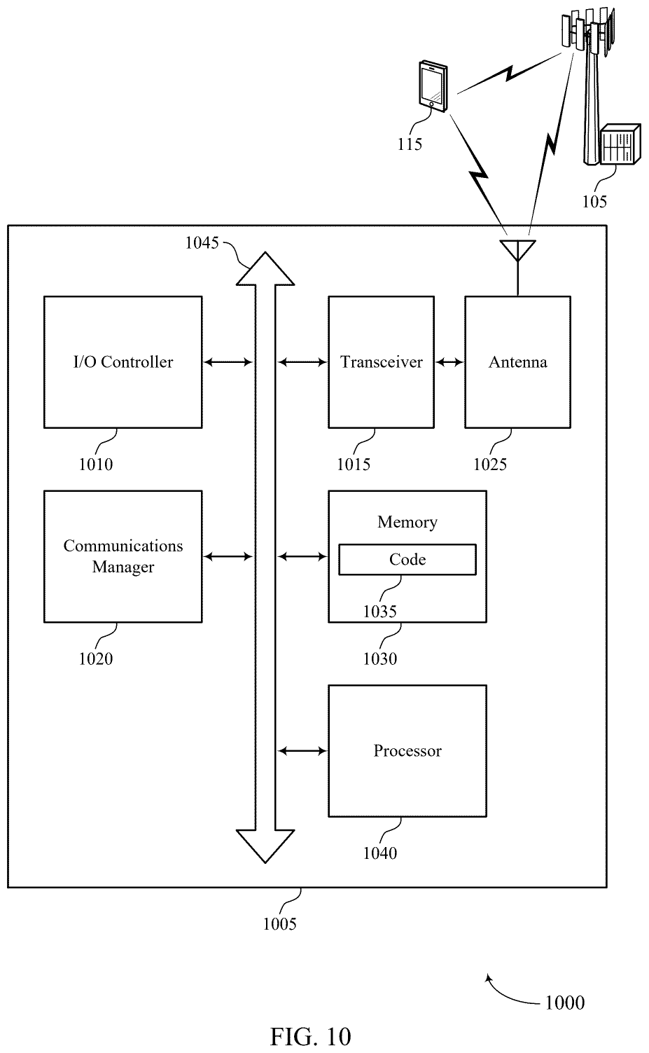

FIG. 10 shows a diagram of a system 1000 including a device 1005 that supports RRC state transition based on system information acquisition from an NES cell in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting RRC state transition based on system information acquisition from an NES cell). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communication in accordance with examples as disclosed herein. For example, the communications manager 1020 is capable of, configured to, or operable to support a means for transmitting, to a first network entity via a random access message, information indicative of a request by the UE to remain in an idle state or an inactive state associated with the first network entity. The communications manager 1020 is capable of, configured to, or operable to support a means for receiving, from the first network entity, a response message associated with the random access message that indicates a mode of operation for the UE in accordance with the request by the UE to remain in the idle state or the inactive state associated with the first network entity. The communications manager 1020 is capable of, configured to, or operable to support a means for monitoring for one or more paging messages from the first network entity or a second network entity in accordance with the mode of operation indicated by the response message.

Additionally, or alternatively, the communications manager 1020 may support wireless communication in accordance with examples as disclosed herein. For example, the communications manager 1020 is capable of, configured to, or operable to support a means for transmitting a random access message to a first network entity. The communications manager 1020 is capable of, configured to, or operable to support a means for receiving, from the first network entity, one or more SIBs in association with transmitting the random access message. The communications manager 1020 is capable of, configured to, or operable to support a means for monitoring for a response message associated with the random access message within a time span that is based on receiving the one or more SIBs in association with transmitting the random access message.

By including or configuring the communications manager 1020 in accordance with examples as described herein, the device 1005 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of RRC state transition based on system information acquisition from an NES cell as described herein, or the at least one processor 1040 and the at least one memory 1030 may be otherwise configured to, individually or collectively, perform or support such operations.

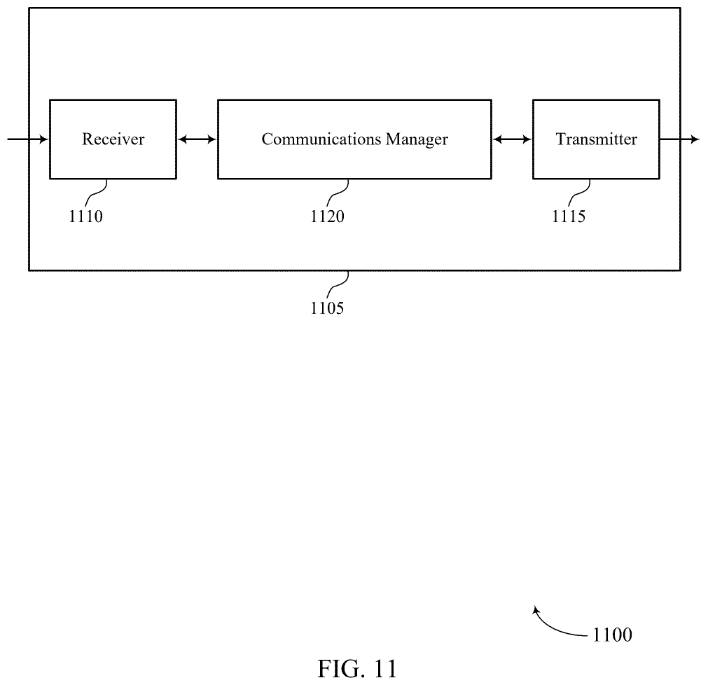

FIG. 11 shows a block diagram 1100 of a device 1105 that supports RRC state transition based on system information acquisition from an NES cell in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of RRC state transition based on system information acquisition from an NES cell as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. For example, the communications manager 1120 is capable of, configured to, or operable to support a means for obtaining, via a random access message, information indicative of a request by a UE to remain in an idle state or an inactive state with respect to the first network entity. The communications manager 1120 is capable of, configured to, or operable to support a means for outputting a response message associated with the random access message that indicates a mode of operation for the UE in accordance with the request by the UE to remain in the idle state or the inactive state with respect to the first network entity. The communications manager 1120 is capable of, configured to, or operable to support a means for selectively outputting one or more paging messages in accordance with the mode of operation indicated by the response message.

Additionally, or alternatively, the communications manager 1120 may support wireless communication in accordance with examples as disclosed herein. For example, the communications manager 1120 is capable of, configured to, or operable to support a means for obtaining a random access message. The communications manager 1120 is capable of, configured to, or operable to support a means for outputting one or more SIBs in association with obtaining the random access message. The communications manager 1120 is capable of, configured to, or operable to support a means for outputting a response message associated with the random access message within a time span that is based on outputting the one or more SIBs in association with obtaining the random access message.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, and more efficient utilization of communication resources.

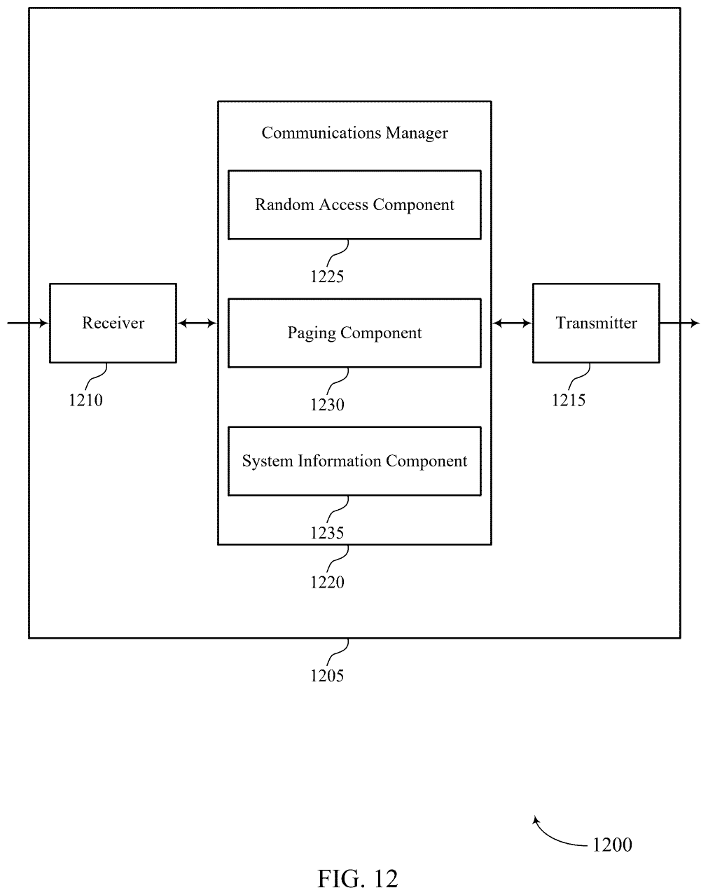

FIG. 12 shows a block diagram 1200 of a device 1205 that supports RRC state transition based on system information acquisition from an NES cell in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of RRC state transition based on system information acquisition from an NES cell as described herein. For example, the communications manager 1220 may include a random access component 1225, a paging component 1230, a system information component 1235, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication in accordance with examples as disclosed herein. The random access component 1225 is capable of, configured to, or operable to support a means for obtaining, via a random access message, information indicative of a request by a UE to remain in an idle state or an inactive state with respect to the first network entity. The random access component 1225 is capable of, configured to, or operable to support a means for outputting a response message associated with the random access message that indicates a mode of operation for the UE in accordance with the request by the UE to remain in the idle state or the inactive state with respect to the first network entity. The paging component 1230 is capable of, configured to, or operable to support a means for selectively outputting one or more paging messages in accordance with the mode of operation indicated by the response message.

Additionally, or alternatively, the communications manager 1220 may support wireless communication in accordance with examples as disclosed herein. The random access component 1225 is capable of, configured to, or operable to support a means for obtaining a random access message. The system information component 1235 is capable of, configured to, or operable to support a means for outputting one or more SIBs in association with obtaining the random access message. The random access component 1225 is capable of, configured to, or operable to support a means for outputting a response message associated with the random access message within a time span that is based on outputting the one or more SIBs in association with obtaining the random access message.

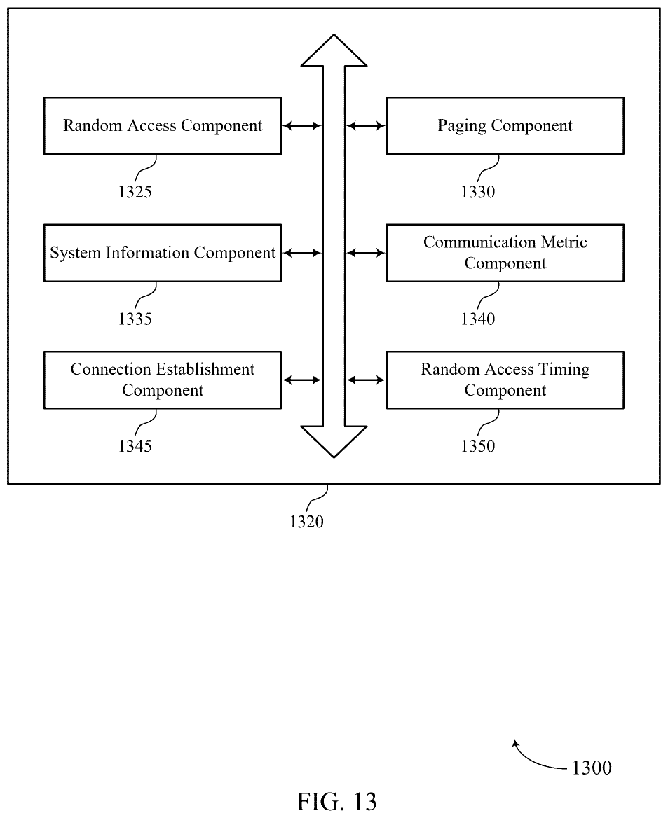

FIG. 13 shows a block diagram 1300 of a communications manager 1320 that supports RRC state transition based on system information acquisition from an NES cell in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of RRC state transition based on system information acquisition from an NES cell as described herein. For example, the communications manager 1320 may include a random access component 1325, a paging component 1330, a system information component 1335, a communication metric component 1340, a connection establishment component 1345, a random access timing component 1350, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication in accordance with examples as disclosed herein. The random access component 1325 is capable of, configured to, or operable to support a means for obtaining, via a random access message, information indicative of a request by a UE to remain in an idle state or an inactive state with respect to the first network entity. In some examples, the random access component 1325 is capable of, configured to, or operable to support a means for outputting a response message associated with the random access message that indicates a mode of operation for the UE in accordance with the request by the UE to remain in the idle state or the inactive state with respect to the first network entity. The paging component 1330 is capable of, configured to, or operable to support a means for selectively outputting one or more paging messages in accordance with the mode of operation indicated by the response message.

In some examples, the communication metric component 1340 is capable of, configured to, or operable to support a means for obtaining an indication of a metric associated with communication between the UE and a second network entity, where outputting the response message that indicates the mode of operation for the UE is in association with obtaining the indication of the metric associated with the communication between the UE and the second network entity.

In some examples, the communication metric component 1340 is capable of, configured to, or operable to support a means for outputting, in association with obtaining the random access message, a request for the metric associated with the communication between the UE and the second network entity, where obtaining the indication of the metric is in association with receiving the request.

In some examples, the random access message includes the indication of the metric associated with the communication between the UE and the second network entity.

In some examples, to support outputting the response message that indicates the mode of operation for the UE, the paging component 1330 is capable of, configured to, or operable to support a means for outputting an indication to monitor a paging channel associated with the second network entity in accordance with the metric satisfying a threshold value, where the mode of operation includes monitoring the paging channel associated with the second network entity.

In some examples, to support outputting the response message that indicates the mode of operation for the UE, the paging component 1330 is capable of, configured to, or operable to support a means for outputting an indication to monitor a paging channel associated with the first network entity in accordance with the metric failing to satisfy a threshold value, where the mode of operation includes monitoring the paging channel associated with the first network entity.

In some examples, the metric associated with the communication between the UE and the second network entity includes an absolute value associated with the communication between the UE and the second network entity.

In some examples, the metric associated with the communication between the UE and the second network entity includes a relative value associated with a difference between a first metric associated with the communication between the UE and the second network entity and a second metric associated with second communication between the UE and the first network entity.

In some examples, the metric associated with the communication between the UE and the second network entity includes a signal strength metric or a signal quality metric.

In some examples, to support outputting the response message that indicates the mode of operation for the UE, the paging component 1330 is capable of, configured to, or operable to support a means for outputting an indication to monitor a paging channel associated with a second network entity in accordance with the first network entity operating in accordance with an NES mode, where the mode of operation includes monitoring the paging channel associated with the second network entity.

In some examples, the random access message further includes one or more parameters associated with the UE. In some examples, the mode of operation is further in accordance with the one or more parameters associated with the UE.

In some examples, the one or more parameters associated with the UE include a device type associated with the UE, a service type associated with the UE, a radio capability associated with the UE, or any combination thereof.

In some examples, the random access component 1325 is capable of, configured to, or operable to support a means for obtaining a random access preamble via a random access channel occasion associated with the first network entity, where obtaining the random access message is in association with obtaining the random access preamble.

In some examples, an uplink shared channel occasion is associated with the random access channel occasion. In some examples, the first network entity obtains the random access message via the uplink shared channel occasion.

In some examples, the random access component 1325 is capable of, configured to, or operable to support a means for outputting a random access response associated with the random access preamble, where the random access response indicates an uplink shared channel occasion, and where the first network entity obtains the random access message via the uplink shared channel occasion.

In some examples, the system information component 1335 is capable of, configured to, or operable to support a means for outputting one or more SIBs in association with obtaining the random access preamble or the random access message.

In some examples, the random access message is a msg3 of a four-step random access procedure or a data portion of a msgA of a two-step random access procedure. In some examples, the first network entity is a cell operating in accordance with an NES mode. In some examples, the request by the UE to remain in the idle state or the inactive state associated with the first network entity is associated with a request to monitor a paging channel associated with the first network entity.

Additionally, or alternatively, the communications manager 1320 may support wireless communication in accordance with examples as disclosed herein. In some examples, the random access component 1325 is capable of, configured to, or operable to support a means for obtaining a random access message. The system information component 1335 is capable of, configured to, or operable to support a means for outputting one or more SIBs in association with obtaining the random access message. In some examples, the random access component 1325 is capable of, configured to, or operable to support a means for outputting a response message associated with the random access message within a time span that is based on outputting the one or more SIBs in association with obtaining the random access message.

In some examples, the connection establishment component 1345 is capable of, configured to, or operable to support a means for obtaining, via the random access message or a second random access message, first information indicative of a request by a UE to enter a connected state associated with the first network entity and second information indicative of one or more parameters associated with the UE.

In some examples, the connection establishment component 1345 is capable of, configured to, or operable to support a means for outputting an acceptance or a rejection of the request by the UE to enter the connected state associated with the first network entity based on the one or more parameters.

In some examples, the one or more SIBs are based on the one or more parameters associated with the UE.

In some examples, the one or more parameters include a device type associated with the UE, a service type associated with the UE, a radio capability associated with the UE, or any combination thereof.

In some examples, the random access timing component 1350 is capable of, configured to, or operable to support a means for obtaining an indication of an extension time associated with a time window corresponding to the response message, where the time span includes the time window and the extension time in accordance with outputting the one or more SIBs in association with obtaining the random access message.

In some examples, the random access timing component 1350 is capable of, configured to, or operable to support a means for outputting the indication of the extension time via the one or more SIBs.

In some examples, to support obtaining the indication of the extension time, the random access timing component 1350 is capable of, configured to, or operable to support a means for retrieving the indication of the extension time from one or more memories of the first network entity in accordance with a rule triggered by outputting the one or more SIBs in association with obtaining the random access message.

In some examples, the random access timing component 1350 is capable of, configured to, or operable to support a means for obtaining an indication of a time offset associated with a time window corresponding to the response message, where the time span includes the time window, and where the time window is offset from a transmission time of the random access message by the time offset in accordance with outputting the one or more SIBs in association with obtaining the random access message.

In some examples, the first network entity outputs the one or more SIBs within a duration of the time offset. In some examples, the first network entity outputs the response message within the time window.

In some examples, the random access timing component 1350 is capable of, configured to, or operable to support a means for outputting the indication of the time offset via the one or more SIBs.

In some examples, to support obtaining the indication of the time offset, the random access timing component 1350 is capable of, configured to, or operable to support a means for retrieving the indication of the time offset from one or more memories of the first network entity in accordance with a rule triggered by outputting the one or more SIBs in association with obtaining the random access message.

In some examples, the random access component 1325 is capable of, configured to, or operable to support a means for obtaining a random access preamble via a random access channel occasion associated with the first network entity, where the random access message includes the random access preamble or is subsequent to the random access preamble.

In some examples, the first network entity obtains the random access message via an uplink shared channel occasion in accordance with the random access message being subsequent to the random access preamble.

In some examples, the random access component 1325 is capable of, configured to, or operable to support a means for outputting a random access response associated with the random access preamble, where the random access response indicates an uplink shared channel occasion, and where, in accordance with the random access message being subsequent to the random access preamble, the first network entity obtains the random access message via the uplink shared channel occasion.

In some examples, the random access message is a msg1 or a msg3 of a four-step random access procedure or a data portion of a msgA of a two-step random access procedure. In some examples, the response message is a msg2 or a msg4 of the four-step random access procedure or a msgB of the two-step random access procedure. In some examples, the time span is associated with a random access response window, a random access contention resolution timer, or a msgB response window. In some examples, the first network entity is a cell operating in accordance with an NES mode.

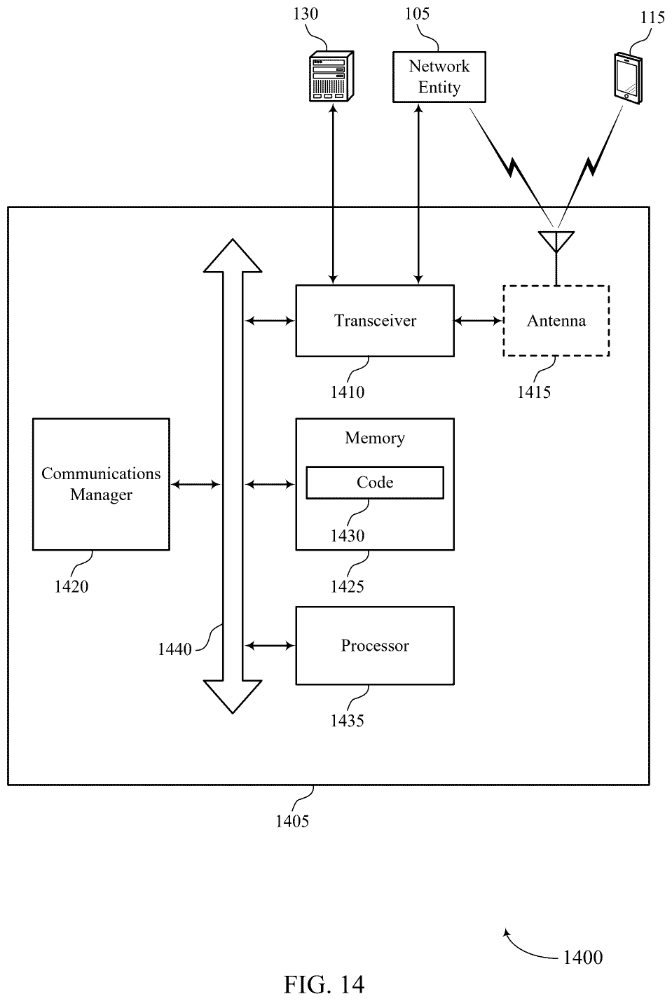

FIG. 14 shows a diagram of a system 1400 including a device 1405 that supports RRC state transition based on system information acquisition from an NES cell in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting RRC state transition based on system information acquisition from an NES cell). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communication in accordance with examples as disclosed herein. For example, the communications manager 1420 is capable of, configured to, or operable to support a means for obtaining, via a random access message, information indicative of a request by a UE to remain in an idle state or an inactive state with respect to the first network entity. The communications manager 1420 is capable of, configured to, or operable to support a means for outputting a response message associated with the random access message that indicates a mode of operation for the UE in accordance with the request by the UE to remain in the idle state or the inactive state with respect to the first network entity. The communications manager 1420 is capable of, configured to, or operable to support a means for selectively outputting one or more paging messages in accordance with the mode of operation indicated by the response message.

Additionally, or alternatively, the communications manager 1420 may support wireless communication in accordance with examples as disclosed herein. For example, the communications manager 1420 is capable of, configured to, or operable to support a means for obtaining a random access message. The communications manager 1420 is capable of, configured to, or operable to support a means for outputting one or more SIBs in association with obtaining the random access message. The communications manager 1420 is capable of, configured to, or operable to support a means for outputting a response message associated with the random access message within a time span that is based on outputting the one or more SIBs in association with obtaining the random access message.

By including or configuring the communications manager 1420 in accordance with examples as described herein, the device 1405 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of RRC state transition based on system information acquisition from an NES cell as described herein, or the at least one processor 1435 and the at least one memory 1425 may be otherwise configured to, individually or collectively, perform or support such operations.

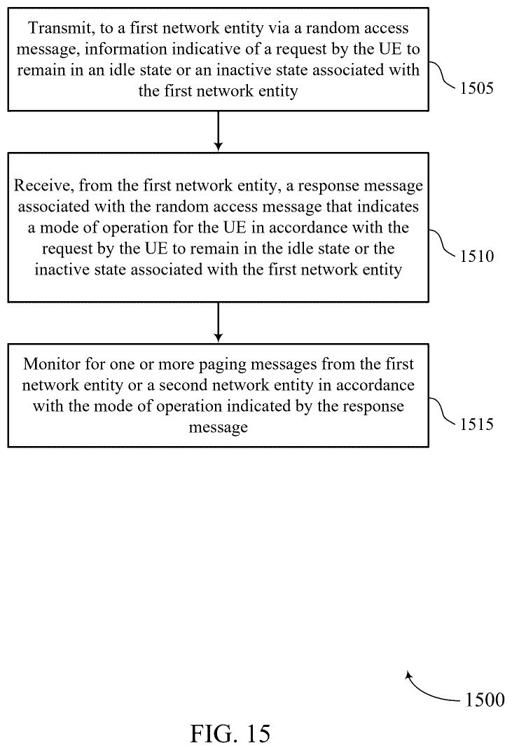

FIG. 15 shows a flowchart illustrating a method 1500 that supports RRC state transition based on system information acquisition from an NES cell in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include transmitting, to a first network entity via a random access message, information indicative of a request by the UE to remain in an idle state or an inactive state associated with the first network entity. The operations of 1505 may be performed in accordance with examples as disclosed herein. In some examples, aspects of the operations of 1505 may be performed by a random access component 925 as described with reference to FIG. 9.

At 1510, the method may include receiving, from the first network entity, a response message associated with the random access message that indicates a mode of operation for the UE in accordance with the request by the UE to remain in the idle state or the inactive state associated with the first network entity. The operations of 1510 may be performed in accordance with examples as disclosed herein. In some examples, aspects of the operations of 1510 may be performed by a random access component 925 as described with reference to FIG. 9.

At 1515, the method may include monitoring for one or more paging messages from the first network entity or a second network entity in accordance with the mode of operation indicated by the response message. The operations of 1515 may be performed in accordance with examples as disclosed herein. In some examples, aspects of the operations of 1515 may be performed by a paging component 930 as described with reference to FIG. 9.

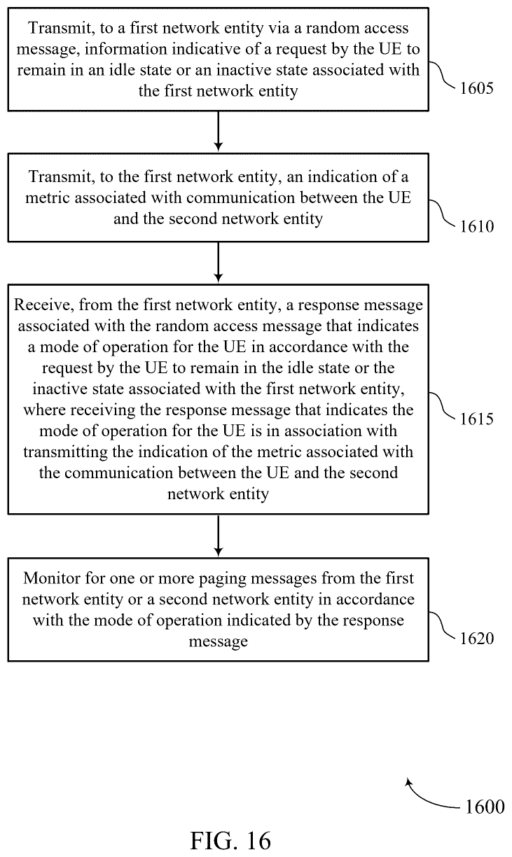

FIG. 16 shows a flowchart illustrating a method 1600 that supports RRC state transition based on system information acquisition from an NES cell in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include transmitting, to a first network entity via a random access message, information indicative of a request by the UE to remain in an idle state or an inactive state associated with the first network entity. The operations of 1605 may be performed in accordance with examples as disclosed herein. In some examples, aspects of the operations of 1605 may be performed by a random access component 925 as described with reference to FIG. 9.

At 1610, the method may include transmitting, to the first network entity, an indication of a metric associated with communication between the UE and the second network entity. The operations of 1610 may be performed in accordance with examples as disclosed herein. In some examples, aspects of the operations of 1610 may be performed by a communication metric component 940 as described with reference to FIG. 9.

At 1615, the method may include receiving, from the first network entity, a response message associated with the random access message that indicates a mode of operation for the UE in accordance with the request by the UE to remain in the idle state or the inactive state associated with the first network entity, where receiving the response message that indicates the mode of operation for the UE is in association with transmitting the indication of the metric associated with the communication between the UE and the second network entity. The operations of 1615 may be performed in accordance with examples as disclosed herein. In some examples, aspects of the operations of 1615 may be performed by a random access component 925 as described with reference to FIG. 9.

At 1620, the method may include monitoring for one or more paging messages from the first network entity or a second network entity in accordance with the mode of operation indicated by the response message. The operations of 1620 may be performed in accordance with examples as disclosed herein. In some examples, aspects of the operations of 1620 may be performed by a paging component 930 as described with reference to FIG. 9.

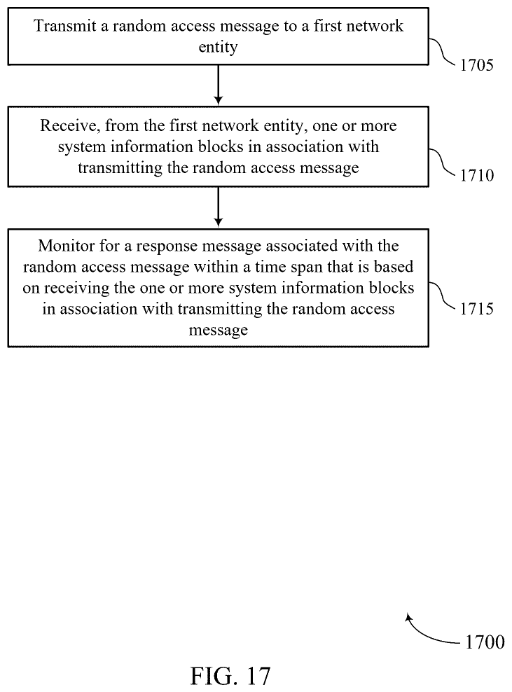

FIG. 17 shows a flowchart illustrating a method 1700 that supports RRC state transition based on system information acquisition from an NES cell in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include transmitting a random access message to a first network entity. The operations of 1705 may be performed in accordance with examples as disclosed herein. In some examples, aspects of the operations of 1705 may be performed by a random access component 925 as described with reference to FIG. 9.

At 1710, the method may include receiving, from the first network entity, one or more SIBs in association with transmitting the random access message. The operations of 1710 may be performed in accordance with examples as disclosed herein. In some examples, aspects of the operations of 1710 may be performed by a system information component 935 as described with reference to FIG. 9.

At 1715, the method may include monitoring for a response message associated with the random access message within a time span that is based on receiving the one or more SIBs in association with transmitting the random access message. The operations of 1715 may be performed in accordance with examples as disclosed herein. In some examples, aspects of the operations of 1715 may be performed by a random access component 925 as described with reference to FIG. 9.

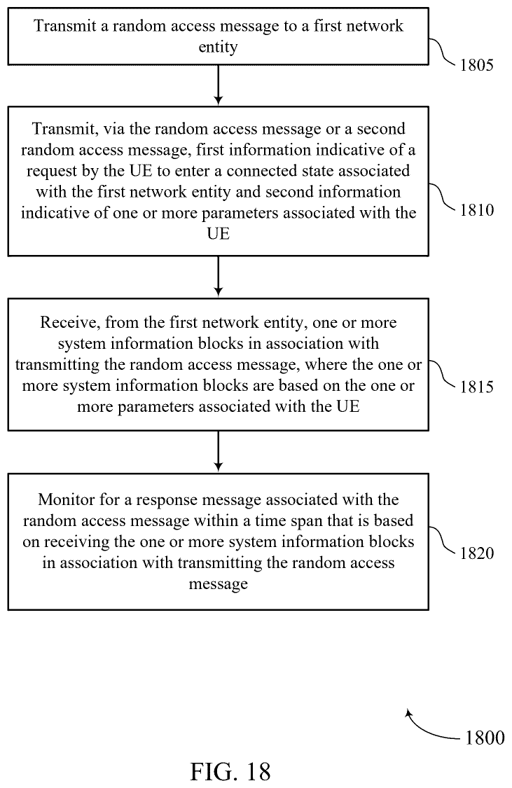

FIG. 18 shows a flowchart illustrating a method 1800 that supports RRC state transition based on system information acquisition from an NES cell in accordance with one or more aspects of the present disclosure. The operations of the method 1800 may be implemented by a UE or its components as described herein. For example, the operations of the method 1800 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1805, the method may include transmitting a random access message to a first network entity. The operations of 1805 may be performed in accordance with examples as disclosed herein. In some examples, aspects of the operations of 1805 may be performed by a random access component 925 as described with reference to FIG. 9.

At 1810, the method may include transmitting, via the random access message or a second random access message, first information indicative of a request by the UE to enter a connected state associated with the first network entity and second information indicative of one or more parameters associated with the UE. The operations of 1810 may be performed in accordance with examples as disclosed herein. In some examples, aspects of the operations of 1810 may be performed by a connection request component 945 as described with reference to FIG. 9.

At 1815, the method may include receiving, from the first network entity, one or more SIBs in association with transmitting the random access message, where the one or more SIBs are based on the one or more parameters associated with the UE. The operations of 1815 may be performed in accordance with examples as disclosed herein. In some examples, aspects of the operations of 1815 may be performed by a system information component 935 as described with reference to FIG. 9.

At 1820, the method may include monitoring for a response message associated with the random access message within a time span that is based on receiving the one or more SIBs in association with transmitting the random access message. The operations of 1820 may be performed in accordance with examples as disclosed herein. In some examples, aspects of the operations of 1820 may be performed by a random access component 925 as described with reference to FIG. 9.

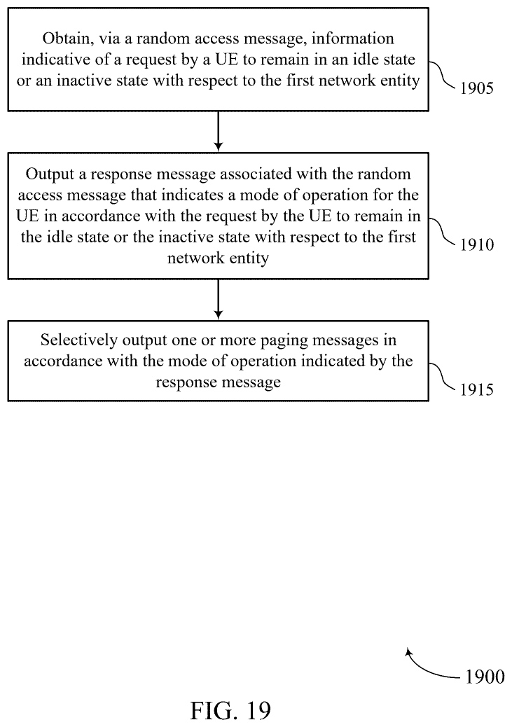

FIG. 19 shows a flowchart illustrating a method 1900 that supports RRC state transition based on system information acquisition from an NES cell in accordance with one or more aspects of the present disclosure. The operations of the method 1900 may be implemented by a network entity or its components as described herein. For example, the operations of the method 1900 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 1905, the method may include obtaining, via a random access message, information indicative of a request by a UE to remain in an idle state or an inactive state with respect to the first network entity. The operations of 1905 may be performed in accordance with examples as disclosed herein. In some examples, aspects of the operations of 1905 may be performed by a random access component 1325 as described with reference to FIG. 13.

At 1910, the method may include outputting a response message associated with the random access message that indicates a mode of operation for the UE in accordance with the request by the UE to remain in the idle state or the inactive state with respect to the first network entity. The operations of 1910 may be performed in accordance with examples as disclosed herein. In some examples, aspects of the operations of 1910 may be performed by a random access component 1325 as described with reference to FIG. 13.

At 1915, the method may include selectively outputting one or more paging messages in accordance with the mode of operation indicated by the response message. The operations of 1915 may be performed in accordance with examples as disclosed herein. In some examples, aspects of the operations of 1915 may be performed by a paging component 1330 as described with reference to FIG. 13.

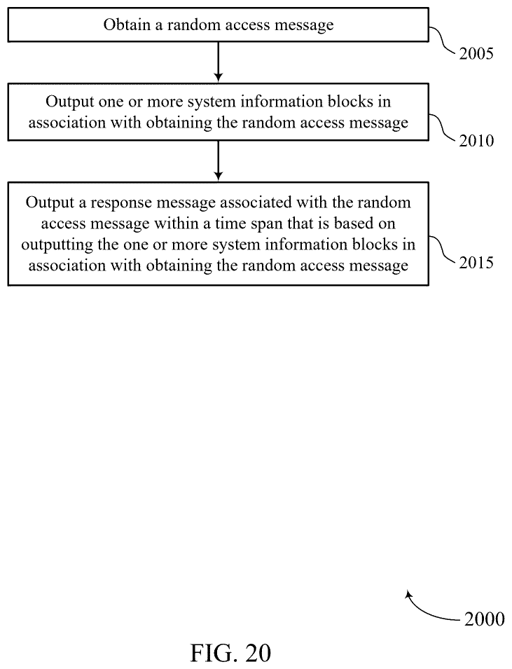

FIG. 20 shows a flowchart illustrating a method 2000 that supports RRC state transition based on system information acquisition from an NES cell in accordance with one or more aspects of the present disclosure. The operations of the method 2000 may be implemented by a network entity or its components as described herein. For example, the operations of the method 2000 may be performed by a network entity as described with reference to FIGS. 1 through 6 and 11 through 14. In some examples, a network entity may execute a set of instructions to control the functional elements of the network entity to perform the described functions. Additionally, or alternatively, the network entity may perform aspects of the described functions using special-purpose hardware.

At 2005, the method may include obtaining a random access message. The operations of 2005 may be performed in accordance with examples as disclosed herein. In some examples, aspects of the operations of 2005 may be performed by a random access component 1325 as described with reference to FIG. 13.

At 2010, the method may include outputting one or more SIBs in association with obtaining the random access message. The operations of 2010 may be performed in accordance with examples as disclosed herein. In some examples, aspects of the operations of 2010 may be performed by a system information component 1335 as described with reference to FIG. 13.

At 2015, the method may include outputting a response message associated with the random access message within a time span that is based on outputting the one or more SIBs in association with obtaining the random access message. The operations of 2015 may be performed in accordance with examples as disclosed herein. In some examples, aspects of the operations of 2015 may be performed by a random access component 1325 as described with reference to FIG. 13.

The following provides an overview of aspects of the present disclosure:

Aspect 1: A method for wireless communication at a UE, comprising: transmitting, to a first network entity via a random access message, information indicative of a request by the UE to remain in an idle state or an inactive state associated with the first network entity; receiving, from the first network entity, a response message associated with the random access message that indicates a mode of operation for the UE in accordance with the request by the UE to remain in the idle state or the inactive state associated with the first network entity; and monitoring for one or more paging messages from the first network entity or a second network entity in accordance with the mode of operation indicated by the response message.

Aspect 2: The method of aspect 1, further comprising: transmitting, to the first network entity, an indication of a metric associated with communication between the UE and the second network entity, wherein receiving the response message that indicates the mode of operation for the UE is in association with transmitting the indication of the metric associated with the communication between the UE and the second network entity.

Aspect 3: The method of aspect 2, further comprising: receiving, from the first network entity in association with transmitting the random access message, a request for the metric associated with the communication between the UE and the second network entity, wherein transmitting the indication of the metric is in association with receiving the request.

Aspect 4: The method of any of aspects 2-3, wherein the UE includes the indication of the metric associated with the communication between the UE and the second network entity in the random access message.

Aspect 5: The method of any of aspects 2-4, wherein receiving the response message that indicates the mode of operation for the UE comprises: receiving an indication to monitor a paging channel associated with the second network entity in accordance with the metric satisfying a threshold value, wherein the mode of operation comprises monitoring the paging channel associated with the second network entity.

Aspect 6: The method of any of aspects 2-4, wherein receiving the response message that indicates the mode of operation for the UE comprises: receiving an indication to monitor a paging channel associated with the first network entity in accordance with the metric failing to satisfy a threshold value, wherein the mode of operation comprises monitoring the paging channel associated with the first network entity.

Aspect 7: The method of any of aspects 2-6, wherein the metric associated with the communication between the UE and the second network entity comprises an absolute value associated with the communication between the UE and the second network entity.

Aspect 8: The method of any of aspects 2-6, wherein the metric associated with the communication between the UE and the second network entity comprises a relative value associated with a difference between a first metric associated with the communication between the UE and the second network entity and a second metric associated with second communication between the UE and the first network entity.

Aspect 9: The method of any of aspects 2-8, wherein the metric associated with the communication between the UE and the second network entity comprises a signal strength metric or a signal quality metric.

Aspect 10: The method of any of aspects 1-5 or 7-9, wherein receiving the response message that indicates the mode of operation for the UE comprises: receiving an indication to monitor a paging channel associated with the second network entity in accordance with the first network entity operating in accordance with an NES mode, wherein the mode of operation comprises monitoring the paging channel associated with the second network entity.

Aspect 11: The method of any of aspects 1-10, wherein the random access message further includes one or more parameters associated with the UE, and the mode of operation is further in accordance with the one or more parameters associated with the UE.

Aspect 12: The method of aspect 11, wherein the one or more parameters associated with the UE comprise a device type associated with the UE, a service type associated with the UE, a radio capability associated with the UE, or any combination thereof.

Aspect 13: The method of any of aspects 1-12, further comprising: receiving, from the second network entity, an indication of one or more random access parameters associated with the first network entity, wherein the one or more random access parameters indicate at least a random access channel occasion associated with the first network entity; and transmitting a random access preamble via the random access channel occasion associated with the first network entity, wherein transmitting the random access message is in association with transmitting the random access preamble.

Aspect 14: The method of aspect 13, wherein the one or more random access parameters further indicate an uplink shared channel occasion associated with the random access channel occasion, and the UE transmits the random access message via the uplink shared channel occasion.

Aspect 15: The method of any of aspects 13-14, further comprising: receiving, from the first network entity, a random access response associated with the random access preamble, wherein the random access response indicates an uplink shared channel occasion, and wherein the UE transmits the random access message via the uplink shared channel occasion.

Aspect 16: The method of any of aspects 13-15, further comprising: receiving, from the first network entity, one or more SIBs in association with transmitting the random access preamble or the random access message.

Aspect 17: The method of any of aspects 1-16, wherein the random access message is a msg3 of a four-step random access procedure or a data portion of a msgA of a two-step random access procedure.

Aspect 18: The method of any of aspects 1-17, wherein the first network entity is a cell operating in accordance with an NES mode.

Aspect 19: The method of any of aspects 1-18, wherein the request by the UE to remain in the idle state or the inactive state associated with the first network entity is associated with a request to monitor a paging channel associated with the first network entity.

Aspect 20: A method for wireless communication at a UE, comprising: transmitting a random access message to a first network entity; receiving, from the first network entity, one or more SIBs in association with transmitting the random access message; and monitoring for a response message associated with the random access message within a time span that is based at least in part on receiving the one or more SIBs in association with transmitting the random access message.

Aspect 21: The method of aspect 20, further comprising: transmitting, via the random access message or a second random access message, first information indicative of a request by the UE to enter a connected state associated with the first network entity and second information indicative of one or more parameters associated with the UE.

Aspect 22: The method of aspect 21, further comprising: receiving, from the first network entity, an acceptance or a rejection of the request by the UE to enter the connected state associated with the first network entity based at least in part on the one or more parameters.

Aspect 23: The method of any of aspects 21-22, wherein the one or more SIBs are based at least in part on the one or more parameters associated with the UE.

Aspect 24: The method of any of aspects 21-23, wherein the one or more parameters comprise a device type associated with the UE, a service type associated with the UE, a radio capability associated with the UE, or any combination thereof.

Aspect 25: The method of any of aspects 20-24, further comprising: obtaining an indication of an extension time associated with a time window corresponding to the response message, wherein the time span includes the time window and the extension time in accordance with receiving the one or more SIBs in association with transmitting the random access message.

Aspect 26: The method of aspect 25, wherein obtaining the indication of the extension time comprises: receiving the indication of the extension time from a second network entity via RRC signaling, one or more MAC-CEs, or DCI.

Aspect 27: The method of any of aspects 25-26, wherein obtaining the indication of the extension time comprises: receiving the indication of the extension time from the first network entity via the one or more SIBs.

Aspect 28: The method of any of aspects 25-27, wherein obtaining the indication of the extension time comprises: retrieving the indication of the extension time from one or more memories of the UE in accordance with a rule triggered by receiving the one or more SIBs in association with transmitting the random access message.

Aspect 29: The method of any of aspects 20-28, further comprising: obtaining an indication of a time offset associated with a time window corresponding to the response message, wherein the time span includes the time window, and wherein the time window is offset from a transmission time of the random access message by the time offset in accordance with receiving the one or more SIBs in association with transmitting the random access message.

Aspect 30: The method of aspect 29, wherein the UE receives the one or more SIBs within a duration of the time offset, and the UE receives the response message within the time window.

Aspect 31: The method of any of aspects 29-30, wherein obtaining the indication of the time offset comprises: receiving the indication of the time offset from a second network entity via RRC signaling, one or more MAC-CEs, or DCI.

Aspect 32: The method of any of aspects 29-31, wherein obtaining the indication of the time offset comprises: receiving the indication of the time offset from the first network entity via the one or more SIBs.

Aspect 33: The method of any of aspects 29-32, wherein obtaining the indication of the time offset comprises: retrieving the indication of the time offset from one or more memories of the UE in accordance with a rule triggered by receiving the one or more SIBs in association with transmitting the random access message.

Aspect 34: The method of any of aspects 20-33, further comprising: receiving, from a second network entity, an indication of one or more random access parameters associated with the first network entity, wherein the one or more random access parameters indicate at least a random access channel occasion associated with the first network entity; and transmitting a random access preamble via the random access channel occasion associated with the first network entity, wherein the random access message comprises the random access preamble or is subsequent to the random access preamble.

Aspect 35: The method of aspect 34, wherein the one or more random access parameters further indicate an uplink shared channel occasion associated with the random access channel occasion, and in accordance with the random access message being subsequent to the random access preamble, the UE transmits the random access message via the uplink shared channel occasion.

Aspect 36: The method of any of aspects 34-35, further comprising: receiving, from the first network entity, a random access response associated with the random access preamble, wherein the random access response indicates an uplink shared channel occasion, and wherein, in accordance with the random access message being subsequent to the random access preamble, the UE transmits the random access message via the uplink shared channel occasion.

Aspect 37: The method of any of aspects 20-36, wherein the random access message is a msg1 or a msg3 of a four-step random access procedure or a data portion of a msgA of a two-step random access procedure, and the response message is a msg2 or a msg4 of the four-step random access procedure or a msgB of the two-step random access procedure.

Aspect 38: The method of any of aspects 20-37, wherein the time span is associated with a random access response window, a random access contention resolution timer, or a msgB response window.

Aspect 39: The method of any of aspects 20-38, wherein the first network entity is a cell operating in accordance with an NES mode.

Aspect 40: A method for wireless communication at a first network entity, comprising: obtaining, via a random access message, information indicative of a request by a UE to remain in an idle state or an inactive state with respect to the first network entity; outputting a response message associated with the random access message that indicates a mode of operation for the UE in accordance with the request by the UE to remain in the idle state or the inactive state with respect to the first network entity; and selectively outputting one or more paging messages in accordance with the mode of operation indicated by the response message.

Aspect 41: The method of aspect 40, further comprising: obtaining an indication of a metric associated with communication between the UE and a second network entity, wherein outputting the response message that indicates the mode of operation for the UE is in association with obtaining the indication of the metric associated with the communication between the UE and the second network entity.

Aspect 42: The method of aspect 41, further comprising: outputting, in association with obtaining the random access message, a request for the metric associated with the communication between the UE and the second network entity, wherein obtaining the indication of the metric is in association with receiving the request.

Aspect 43: The method of any of aspects 41-42, wherein the random access message includes the indication of the metric associated with the communication between the UE and the second network entity.

Aspect 44: The method of any of aspects 41-43, wherein outputting the response message that indicates the mode of operation for the UE comprises: outputting an indication to monitor a paging channel associated with the second network entity in accordance with the metric satisfying a threshold value, wherein the mode of operation comprises monitoring the paging channel associated with the second network entity.

Aspect 45: The method of any of aspects 41-43, wherein outputting the response message that indicates the mode of operation for the UE comprises: outputting an indication to monitor a paging channel associated with the first network entity in accordance with the metric failing to satisfy a threshold value, wherein the mode of operation comprises monitoring the paging channel associated with the first network entity.

Aspect 46: The method of any of aspects 41-45, wherein the metric associated with the communication between the UE and the second network entity comprises an absolute value associated with the communication between the UE and the second network entity.

Aspect 47: The method of any of aspects 41-45, wherein the metric associated with the communication between the UE and the second network entity comprises a relative value associated with a difference between a first metric associated with the communication between the UE and the second network entity and a second metric associated with second communication between the UE and the first network entity.

Aspect 48: The method of any of aspects 41-47, wherein the metric associated with the communication between the UE and the second network entity comprises a signal strength metric or a signal quality metric.

Aspect 49: The method of any of aspects 40-44 or 46-48, wherein outputting the response message that indicates the mode of operation for the UE comprises: outputting an indication to monitor a paging channel associated with a second network entity in accordance with the first network entity operating in accordance with an NES mode, wherein the mode of operation comprises monitoring the paging channel associated with the second network entity.

Aspect 50: The method of any of aspects 40-49, wherein the random access message further includes one or more parameters associated with the UE, and the mode of operation is further in accordance with the one or more parameters associated with the UE.

Aspect 51: The method of aspect 50, wherein the one or more parameters associated with the UE comprise a device type associated with the UE, a service type associated with the UE, a radio capability associated with the UE, or any combination thereof.

Aspect 52: The method of any of aspects 40-51, further comprising: obtaining a random access preamble via a random access channel occasion associated with the first network entity, wherein obtaining the random access message is in association with obtaining the random access preamble.

Aspect 53: The method of aspect 52, wherein an uplink shared channel occasion is associated with the random access channel occasion, and the first network entity obtains the random access message via the uplink shared channel occasion.

Aspect 54: The method of any of aspects 52-53, further comprising: outputting a random access response associated with the random access preamble, wherein the random access response indicates an uplink shared channel occasion, and wherein the first network entity obtains the random access message via the uplink shared channel occasion.

Aspect 55: The method of any of aspects 52-54, further comprising: outputting one or more SIBs in association with obtaining the random access preamble or the random access message.

Aspect 56: The method of any of aspects 40-55, wherein the random access message is a msg3 of a four-step random access procedure or a data portion of a msgA of a two-step random access procedure.

Aspect 57: The method of any of aspects 40-56, wherein the first network entity is a cell operating in accordance with an NES mode.

Aspect 58: The method of any of aspects 40-57, wherein the request by the UE to remain in the idle state or the inactive state associated with the first network entity is associated with a request to monitor a paging channel associated with the first network entity.

Aspect 59: A method for wireless communication at a first network entity, comprising: obtaining a random access message; outputting one or more SIBs in association with obtaining the random access message; and outputting a response message associated with the random access message within a time span that is based at least in part on outputting the one or more SIBs in association with obtaining the random access message.

Aspect 60: The method of aspect 59, further comprising: obtaining, via the random access message or a second random access message, first information indicative of a request by a UE to enter a connected state associated with the first network entity and second information indicative of one or more parameters associated with the UE.

Aspect 61: The method of aspect 60, further comprising: outputting an acceptance or a rejection of the request by the UE to enter the connected state associated with the first network entity based at least in part on the one or more parameters.

Aspect 62: The method of any of aspects 60-61, wherein the one or more SIBs are based at least in part on the one or more parameters associated with the UE.

Aspect 63: The method of any of aspects 60-62, wherein the one or more parameters comprise a device type associated with the UE, a service type associated with the UE, a radio capability associated with the UE, or any combination thereof.

Aspect 64: The method of any of aspects 59-63, further comprising: obtaining an indication of an extension time associated with a time window corresponding to the response message, wherein the time span includes the time window and the extension time in accordance with outputting the one or more SIBs in association with obtaining the random access message.

Aspect 65: The method of aspect 64, further comprising: outputting the indication of the extension time via the one or more SIBs.

Aspect 66: The method of any of aspects 64-65, wherein obtaining the indication of the extension time comprises: retrieving the indication of the extension time from one or more memories of the first network entity in accordance with a rule triggered by outputting the one or more SIBs in association with obtaining the random access message.

Aspect 67: The method of any of aspects 59-66, further comprising: obtaining an indication of a time offset associated with a time window corresponding to the response message, wherein the time span includes the time window, and wherein the time window is offset from a transmission time of the random access message by the time offset in accordance with outputting the one or more SIBs in association with obtaining the random access message.

Aspect 68: The method of aspect 67, wherein the first network entity outputs the one or more SIBs within a duration of the time offset, and the first network entity outputs the response message within the time window.

Aspect 69: The method of any of aspects 67-68, further comprising: outputting the indication of the time offset via the one or more SIBs.

Aspect 70: The method of any of aspects 67-69, wherein obtaining the indication of the time offset comprises: retrieving the indication of the time offset from one or more memories of the first network entity in accordance with a rule triggered by outputting the one or more SIBs in association with obtaining the random access message.

Aspect 71: The method of any of aspects 59-70, further comprising: obtaining a random access preamble via a random access channel occasion associated with the first network entity, wherein the random access message comprises the random access preamble or is subsequent to the random access preamble.

Aspect 72: The method of aspect 71, wherein the first network entity obtains the random access message via an uplink shared channel occasion in accordance with the random access message being subsequent to the random access preamble.

Aspect 73: The method of any of aspects 71-72, further comprising: outputting a random access response associated with the random access preamble, wherein the random access response indicates an uplink shared channel occasion, and wherein, in accordance with the random access message being subsequent to the random access preamble, the first network entity obtains the random access message via the uplink shared channel occasion.

Aspect 74: The method of any of aspects 59-73, wherein the random access message is a msg1 or a msg3 of a four-step random access procedure or a data portion of a msgA of a two-step random access procedure, and the response message is a msg2 or a msg4 of the four-step random access procedure or a msgB of the two-step random access procedure.

Aspect 75: The method of any of aspects 59-74, wherein the time span is associated with a random access response window, a random access contention resolution timer, or a msgB response window.

Aspect 76: The method of any of aspects 59-75, wherein the first network entity is a cell operating in accordance with an NES mode.

Aspect 77: A UE for wireless communication, comprising one or more memories storing processor-executable code, and one or more processors coupled with the one or more memories and individually or collectively operable to execute the code to cause the UE to perform a method of any of aspects 1-19.

Aspect 78: A UE for wireless communication, comprising at least one means for performing a method of any of aspects 1-19.

Aspect 79: A non-transitory computer-readable medium storing code for wireless communication, the code comprising instructions executable by one or more processors to perform a method of any of aspects 1-19.

Aspect 80: A UE for wireless communication, comprising one or more memories storing processor-executable code, and one or more processors coupled with the one or more memories and individually or collectively operable to execute the code to cause the UE to perform a method of any of aspects 20-39.

Aspect 81: A UE for wireless communication, comprising at least one means for performing a method of any of aspects 20-39.

Aspect 82: A non-transitory computer-readable medium storing code for wireless communication, the code comprising instructions executable by one or more processors to perform a method of any of aspects 20-39.

Aspect 83: A first network entity for wireless communication, comprising one or more memories storing processor-executable code, and one or more processors coupled with the one or more memories and individually or collectively operable to execute the code to cause the first network entity to perform a method of any of aspects 40-58.

Aspect 84: A first network entity for wireless communication, comprising at least one means for performing a method of any of aspects 40-58.

Aspect 85: A non-transitory computer-readable medium storing code for wireless communication, the code comprising instructions executable by one or more processors to perform a method of any of aspects 40-58.

Aspect 86: A first network entity for wireless communication, comprising one or more memories storing processor-executable code, and one or more processors coupled with the one or more memories and individually or collectively operable to execute the code to cause the first network entity to perform a method of any of aspects 59-76.

Aspect 87: A first network entity for wireless communication, comprising at least one means for performing a method of any of aspects 59-76.

Aspect 88: A non-transitory computer-readable medium storing code for wireless communication, the code comprising instructions executable by one or more processors to perform a method of any of aspects 59-76.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
transmit a random access message to a first network entity;
receive, from the first network entity, one or more system information blocks in association with transmitting the random access message; and
monitor for a response message associated with the random access message within a time span that is based at least in part on receiving the one or more system information blocks in association with transmitting the random access message.

2. The UE of claim 1, wherein the one or more processors are individually or collectively further operable to execute the code to cause the UE to:
transmit, via the random access message or a second random access message, first information indicative of a request by the UE to enter a connected state associated with the first network entity and second information indicative of one or more parameters associated with the UE, wherein the one or more parameters comprise a device type associated with the UE, a service type associated with the UE, a radio capability associated with the UE, or any combination thereof.

3. The UE of claim 2, wherein the one or more processors are individually or collectively further operable to execute the code to cause the UE to:
receive, from the first network entity, an acceptance or a rejection of the request by the UE to enter the connected state associated with the first network entity based at least in part on the one or more parameters.

4. The UE of claim 2, wherein the one or more system information blocks are based at least in part on the one or more parameters associated with the UE.

5. The UE of claim 1, wherein the one or more processors are individually or collectively further operable to execute the code to cause the UE to:
obtain an indication of an extension time associated with a time window corresponding to the response message, wherein the time span includes the time window and the extension time in accordance with receiving the one or more system information blocks in association with transmitting the random access message.

6. The UE of claim 5, wherein, to obtain the indication of the extension time, the one or more processors are individually or collectively operable to execute the code to cause the UE to:
receive the indication of the extension time from a second network entity via radio resource control (RRC) signaling, one or more medium access control (MAC) control elements (MAC-CEs), or downlink control information (DCI);
receive the indication of the extension time from the first network entity via the one or more system information blocks; or
retrieve the indication of the extension time from one or more memories of the UE in accordance with a rule triggered by receiving the one or more system information blocks in association with transmitting the random access message.

7. The UE of claim 1, wherein the one or more processors are individually or collectively further operable to execute the code to cause the UE to:
obtain an indication of a time offset associated with a time window corresponding to the response message, wherein the time span includes the time window, and wherein the time window is offset from a transmission time of the random access message by the time offset in accordance with receiving the one or more system information blocks in association with transmitting the random access message.

8. The UE of claim 7, wherein:
the UE receives the one or more system information blocks within a duration of the time offset; and
the UE receives the response message within the time window.

9. The UE of claim 7, wherein, to obtain the indication of the time offset, the one or more processors are individually or collectively operable to execute the code to cause the UE to:
receive the indication of the time offset from a second network entity via radio resource control (RRC) signaling, one or more medium access control (MAC) control elements (MAC-CEs), or downlink control information (DCI);
receive the indication of the time offset from the first network entity via the one or more system information blocks; or
retrieve the indication of the time offset from one or more memories of the UE in accordance with a rule triggered by receiving the one or more system information blocks in association with transmitting the random access message.

10. The UE of claim 1, wherein the time span is associated with a random access response window, a random access contention resolution timer, or a message B (msgB) response window.

11. A user equipment (UE), comprising:
one or more memories storing processor-executable code; and
one or more processors coupled with the one or more memories and individually or collectively operable to execute the code to cause the UE to:
transmit, to a first network entity via a random access message, information indicative of a request by the UE to remain in an idle state or an inactive state associated with the first network entity;
receive, from the first network entity, a response message associated with the random access message that indicates a mode of operation for the UE in accordance with the request by the UE to remain in the idle state or the inactive state associated with the first network entity; and
monitor for one or more paging messages from the first network entity or a second network entity in accordance with the mode of operation indicated by the response message.

12. The UE of claim 11, wherein the one or more processors are individually or collectively further operable to execute the code to cause the UE to:
transmit, to the first network entity, an indication of a metric associated with communication between the UE and the second network entity, wherein receiving the response message that indicates the mode of operation for the UE is in association with transmitting the indication of the metric associated with the communication between the UE and the second network entity.

13. The UE of claim 12, wherein the one or more processors are individually or collectively further operable to execute the code to cause the UE to:
receive, from the first network entity in association with transmitting the random access message, a request for the metric associated with the communication between the UE and the second network entity, wherein transmitting the indication of the metric is in association with receiving the request.

14. The UE of claim 12, wherein the UE includes the indication of the metric associated with the communication between the UE and the second network entity in the random access message.

15. The UE of claim 12, wherein, to receive the response message that indicates the mode of operation for the UE, the one or more processors are individually or collectively operable to execute the code to cause the UE to:
receive an indication to monitor a first paging channel associated with the first network entity in accordance with the metric failing to satisfy a threshold value, wherein the mode of operation comprises monitoring the first paging channel associated with the first network entity; or
receive an indication to monitor a second paging channel associated with the second network entity in accordance with the metric satisfying the threshold value, wherein the mode of operation comprises monitoring the second paging channel associated with the second network entity.

16. The UE of claim 12, wherein the metric associated with the communication between the UE and the second network entity comprises an absolute value associated with the communication between the UE and the second network entity.

17. The UE of claim 12, wherein the metric associated with the communication between the UE and the second network entity comprises a relative value associated with a difference between a first metric associated with the communication between the UE and the second network entity and a second metric associated with second communication between the UE and the first network entity.

18. The UE of claim 12, wherein the metric associated with the communication between the UE and the second network entity comprises a signal strength metric or a signal quality metric.

19. The UE of claim 11, wherein:
the random access message further includes one or more parameters associated with the UE;
the one or more parameters associated with the UE comprise a device type associated with the UE, a service type associated with the UE, a radio capability associated with the UE, or any combination thereof; and
the mode of operation is further in accordance with the one or more parameters associated with the UE.

20. A method for wireless communication at a user equipment (UE), comprising:
transmitting a random access message to a first network entity;
receiving, from the first network entity, one or more system information blocks in association with transmitting the random access message; and
monitoring for a response message associated with the random access message within a time span that is based at least in part on receiving the one or more system information blocks in association with transmitting the random access message.
